(19) United States
(12) Patent Application Publication
(10) Pub. No.: US 2025/0230737 A1
(43) Pub. Date: Jul. 17, 2025

(54) METHODS, SYSTEMS, AND MEDIA FOR OPTIMIZATION OF FRACTURE PARAMETERS OF SEGMENTED MULTI-CLUSTER FRACTURING IN HORIZONTAL WELLS OF CONTINENTAL SHALES

(71) Applicant: YANGTZE UNIVERSITY, Jingzhou (CN)

(72) Inventors: Wenjun XU, Jingzhou (CN); Yanxin ZHAO, Jingzhou (CN); Lei WANG, Jingzhou (CN); Shun QIU, Jingzhou (CN); Zhengzhe JIA, Jingzhou (CN)

(73) Assignee: YANGTZE UNIVERSITY, Jingzhou (CN)

(21) Appl. No.: 18/791,402

(22) Filed: Jul. 31, 2024

(30) Foreign Application Priority Data
Jan. 16, 2024 (CN) 202410065336.X

(51) Int. Cl. E21B 43/26; G06F 30/28; G06F 113/08

(52) U.S. Cl. CPC E21B 43/26; G06F 30/28; E21B 2200/20; G06F 2113/08

(57) ABSTRACT

The present disclosure may provide a method and a system for optimization of fracture parameters of segmented multi-cluster fracturing in a horizontal well of a continental shale. The method includes: establishing a fracture extension model; performing a layer-crossing extension simulation of a single-cluster hydraulic fracture based on at least one injection displacement and at least one fracturing fluid viscosity to determine engineering parameters for the single-cluster hydraulic fracture; determining engineering parameters for multi-cluster hydraulic fractures based on the engineering parameters for the single-cluster hydraulic fracture; determining, based on the engineering parameters for the multi-cluster hydraulic fractures, an equilibrium expansion index and a ground construction pressure for the multi-cluster hydraulic fractures corresponding to at least one perforation parameter; and filtering an optimal perforation parameter based on the equilibrium expansion index and the ground construction pressure.

### CROSS-REFERENCE RELATED TO APPLICATION

This application claims priority to Chinese Application No. 202410065336.X, filed on Jan. 16, 2024, the entire contents of which are hereby incorporated by reference.

### TECHNICAL FIELD

The present disclosure relates to a technical field of hydraulic fracturing, and in particular, to a method, system and medium for optimization of fracture parameters of segmented multi-cluster fracturing in a horizontal well of a continental shale.

### BACKGROUND

Segmented multi-cluster fracturing in a horizontal well is a key technology for efficient development of shale gas and has been widely applied. Compared to marine shales, continental shales have higher clay content, lower matrix brittleness, and significant interlayer lithological differences, making it difficult to form effective fracture networks and achieve cross-layer extension, which subsequently impacts production enhancement.

To address these issues, Chinese Patent Application CN113850029A discloses an optimization method for perforation parameters of tightly spaced fracturing in horizontal shale gas wells. This method uses a displacement discontinuity technology to develop a fully fluid-solid coupled synchronous propagation model for multiple fractures in tightly spaced fracturing and establishes a set of quantitative evaluation metrics for a degree of uniform hydraulic fracture development. It also provides quantitative criteria and methods for optimizing perforation parameters. However, this method focuses solely on the features of marine shale reservoirs and does not consider the effects of lithological and stress differences in continental shales. Additionally, it only optimizes perforation parameters without addressing the optimization of operational parameters.

Therefore, providing a method for optimization of fracture parameters for segmented multi-cluster fracturing in a horizontal well of a continental shale is beneficial for enhancing the fracture parameters and improving the overall fracturing effectiveness.

### SUMMARY

One or more embodiments of the present disclosure provide a method for optimization of fracture parameters of segmented multi-cluster fracturing in a horizontal well of a continental shale, including: S1: establishing a fully coupling fluid-solid numerical model of multi-cluster fracture extension in a horizontal well of a continental shale gas by using a finite element manner and a cohesive unit manner, and based on an influence of large lithological and stress differences between layers of the continental shale, a development of compartmentalized interlayers, an inter-seam stress interference, and a dynamic distribution of flow rate between clusters, introducing a tubular flow unit; including:

S11: establishing a fluid-solid coupling control equation, a coupling control equation of rock solid skeleton deformation and fluid flow, a mass conservation equation of fluid seepage, and a flow velocity equation of fluid within the rock, respectively, as following equations including:

$${\int }_{V} ( \overline{σ} - {p}_{w} I ) \cdot {δ}_{ε} {d}_{V} = {\int }_{S} t \cdot {δ}_{v} {d}_{S} + {\int }_{V} f \cdot {δ}_{v} {d}_{S} + {\int }_{V} f \cdot {δ}_{v} {d}_{V} , \qquad ( 1 )$$

$${\int }_{V} \frac{1}{J} \frac{d}{dt} ( J {ρ}_{w} {φ}_{w} ) {d}_{V} + {\int }_{S} {ρ}_{w} {φ}_{w} {n}^{T} \cdot {v}_{w} {d}_{s} = 0 , \qquad ( 2 )$$

$${v}_{w} = - \frac{1}{{φ}_{w} g {ρ}_{w}} k ( \frac{\partial {p}_{w}}{\partial x} - {ρ}_{w} g ) , \qquad ( 3 )$$

wherein σ is an effective stress matrix in Pa, p_{w} is a pore pressure in Pa, I is a unit matrix in dimensionless units, δ_{ε} is an imaginary strain rate matrix in s⁻¹, δᵥ is an imaginary velocity vector in m/s; t is a surface force vector in N/m²; f is a body force vector in N/m³; J is a change rate of rock volume in dimensionless units, ρ_{w} is a fluid density in kg/m³; φ_{w} is a porosity in dimensionless units, n^{T} is an external normal direction vector of a surface S in dimensionless units; and x is a space vector in meters; g is a gravitational acceleration in m/s²; and k is a rock skeleton permeability tensor in m/s;
S12: establishing an in-seam fluid flow equation, a fluid tangential flow equation, a fluid mass conservation equation, and a fracturing fluid filtration loss equation, respectively, as following equations including:

$$q = - \frac{{w}^{3}}{12 μ} ∇ p , \qquad ( 4 )$$

$$\frac{{\partial }_{w}}{{\partial }_{t}} + ∇ \cdot + ( {q}_{t} + {q}_{b} ) = Q ( t ) δ ( x , y ) , \qquad ( 5 )$$

$$\{ \begin{matrix}{q}_{t} = {c}_{t} ( {p}_{f} - {p}_{t} ) \\ {q}_{b} = {c}_{b} ( {p}_{f} - {p}_{b} )\end{matrix} , \qquad ( 6 )$$

wherein q is a tangential flow in m³/s; ∇p is a pressure drop gradient in a length direction of a cohesive unit in Pa/m; w is a fracture width in m; and μ is a fracturing fluid viscosity in Pa·s; and qₜ is a normal flow into an upper surface of the cohesive unit, and q_{b} is a normal flow into a lower surface of the cohesive unit in m³/s; cₜ is a filtration loss coefficient of an upper surface of a hydraulic fracture in m³/(Pa·s), c_{b} is a filtration loss coefficient of a lower surface of the hydraulic fracture in m³/(Pa·s); pₜ is a pore pressure at the upper surface of the hydraulic fracture in Pa, and p_{b} is a pore pressure at the lower surface of the hydraulic fracture in Pa; and p_{f} is a fluid pressure within the hydraulic fracture in Pa;
S13: establishing a fracture extension criterion equation, a damage equation for the cohesive unit, and a stiffness degradation criterion equation for evolution of unit damage, as following equations including:

$${\{ \frac{〈 {σ}_{n} 〉}{{σ}_{n}^{0}} \}}^{2} + {\{ \frac{〈 {τ}_{s} 〉}{{τ}_{s}^{0}} \}}^{2} + {\{ \frac{〈 {τ}_{t} 〉}{{τ}_{t}^{0}} \}}^{2} , \qquad ( 7 )$$

$$\{ \begin{matrix}\begin{matrix}{σ}_{n} = \{ \begin{matrix}( 1 - D ) \overline{{σ}_{n}} & \overline{{σ}_{n}} \geq 0 \\ \overline{{σ}_{n}} & \overline{{σ}_{n}} < 0\end{matrix} \\ {τ}_{s} = ( 1 - D ) \overline{{τ}_{s}}\end{matrix} \\ {τ}_{t} = ( 1 - D ) \overline{{τ}_{t}}\end{matrix} , D = \frac{{δ}_{f} ( {δ}_{m} - {δ}_{o} )}{{δ}_{m} ( {δ}_{f} - {δ}_{o} )} , \qquad ( 8 )$$

wherein σₙ is a normal stress actually borne by the cohesive unit in Pa, Tₛ and Tₜ are tangential stresses actually borne by the cohesive unit in two directions in Pa; σₙ^{o} is a maximum tensile resistance capable of being borne by the cohesive unit in Pa, Tₛ^{o} and Tₜ^{o} are maximum shear resistances in two directions capable of being borne by the cohesive unit in Pa, and a symbol ( ) indicates that the normal stress actually borne by the cohesive unit takes positive values only; σₙ^{o} is a tensile resistance of the rock, Tₛ^{o} and Tₜ^{o} are shear resistances of the rock; θ̅ₙ is a stress determined in a normal direction of the cohesive unit according to an undamaged front line elastic criterion under a current strain, T̅ₛ is a stress determined in a tangential direction of the cohesive unit according to the undamaged front line elastic criterion under the current strain; D is a damage factor in dimensionless units and in a range of 0-1, when the damage factor is 0, a material is undamaged, and when the damage factor is 1, the material is fully damaged and the fracture begins to expand; δ₀ is a displacement at a time of initial damage in meters, δ_{f} is a displacement when the cohesive unit is completely destroyed in meters; and δₘ is a maximum displacement attained in a loading process in meters; S14: establishing a fluid dynamic distribution equation among multi-cluster hydraulic fractures, and establishing a fluid energy conservation equation, a wellbore friction pressure drop equation, and a perforation aperture friction pressure drop equation, respectively, as following equations including:

$${P}_{0} = {\sum }_{i}^{N} {P}_{i} + Δ {P}_{w} + Δ {P}_{pf} , ( i = 1 , 2 , … , N ) , \qquad ( 9 )$$

$$Δ {P}_{w} = ρ g Δ Z = ( {C}_{L} + {K}_{i} ) \frac{ρ {v}^{2}}{2} , {C}_{L} = \frac{{f}_{L}}{{D}_{h}} , \qquad ( 10 )$$

$$Δ {P}_{pf} = K \frac{ρ {v}^{2}}{2} , \qquad ( 11 )$$

wherein P₀ is a fluid pressure at an injection node in MPa; Pi is a fluid pressure at an entrance of an ith cluster of the multi-cluster hydraulic fractures in MPa; ΔP_{w} is a wellbore pressure drop friction in MPa; ΔP_{pf} is an aperture pressure drop friction in MPa; and N is a count of perforation clusters within a single fracturing section in clusters; ΔZ is an elevation difference between two nodes of a tubular unit in meters; ΔZ=Z₁−Z₂, Z₁ and Z₂ are elevations of the two nodes in m; ρ is a fluid density in kg/m³; g is the gravitational acceleration in m/s²; v is a flow rate of fluid within the tubular unit in m/s; C_{L} is a loss coefficient; f_{L} is a friction coefficient of a tubular; L is a length of the tubular in meters, Kᵢ is a directional loss coefficient in mm; and Dₕ is a hydraulic diameter or pipe diameter in meters; and K is a pressure loss coefficient of a connecting unit in dimensionless units; and when considering the lithological and stress differences between layers of the continental shale, assigning different rock mechanics and geostress parameters to the layers in conjunction with a real reservoir development feature;

S2: performing a layer-crossing extension simulation of a single-cluster hydraulic fracture under conditions of different injection displacements and fracturing fluid viscosities, and filtering an optimal engineering parameter of the single-cluster hydraulic fracture for realizing a layer-crossing extension with a goal of the hydraulic fracture penetrating through a high-quality reservoir;

S3: calculating an engineering parameter of the multi-cluster hydraulic fractures for realizing the layer-crossing extension based on the filtered engineering parameter of the single-cluster hydraulic fracture for realizing the layer-crossing extension in S2; and

S4: based on the filtered engineering parameter of the multi-cluster hydraulic fractures for realizing the layer-crossing extension in S3, calculating equilibrium expansion indexes of the multi-cluster hydraulic fractures and ground construction pressures under different perforation parameters, filtering an optimal perforation parameter based on a goal of balanced development of the multi-cluster hydraulic fractures and the ground construction pressures not exceeding a safety limit pressure.

### BRIEF DESCRIPTION OF THE DRAWINGS

The present disclosure is further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 is a schematic structural diagram illustrating a system for optimization of fracture parameters of segmented multi-cluster fracturing in a horizontal well of a continental shale according to some embodiments of the present disclosure;

FIG. 2 is an exemplary flowchart illustrating a method for optimization of fracture parameters of segmented multi-cluster fracturing in a horizontal well of a continental shale according to some embodiments of the present disclosure;

FIG. 3 is an exemplary flowchart illustrating a method for optimization of fracture parameters of segmented multi-cluster fracturing in a horizontal well of a continental shale according to some embodiments of the present disclosure;

FIG. 4 is an exemplary schematic diagram illustrating a layer-crossing extension pattern of a single-cluster hydraulic fracture corresponding to different injection displacements and fracturing fluid viscosities of a ZX well according to some embodiments of the present disclosure; and

FIG. 5 is an exemplary schematic diagram illustrating curves of an equilibrium expansion index and a ground construction pressure for the multi-cluster hydraulic fractures corresponding to plans with different count of perforations for single-segment 5-7-cluster fracturing mode in a ZX well according to some embodiments of the present disclosure.

### DETAILED DESCRIPTION

In order to more clearly illustrate the technical solutions of the embodiments of the present disclosure, the accompanying drawings required to be used in the description of the embodiments are briefly described below. Obviously, the accompanying drawings in the following description are only some examples or embodiments of the present disclosure, and it is possible for a person having ordinary skills in the art to apply the present disclosure to other similar scenarios in accordance with these drawings without creative labor. Unless obviously obtained from the context or the context illustrates otherwise, the same numeral in the drawings refers to the same structure or operation.

It should be understood that “system”, “device”, “unit” and/or “module” as used herein is a method for distinguishing different components, elements, parts, portions or assemblies of different levels. However, the words may be replaced by other expressions if other words can achieve the same purpose.

As indicated in the disclosure and claims, the terms “a”, “an”, and/or “the” are not specific to the singular form and may include the plural form unless the context clearly indicates an exception. Generally speaking, the terms “comprising” and “including” only suggest the inclusion of clearly identified steps and elements, and these steps and elements do not constitute an exclusive list, and the method or device may also contain other steps or elements.

The flowchart is used in the present disclosure to illustrate the operations performed by the system according to the embodiments of the present disclosure. It should be understood that the preceding or following operations are not necessarily performed in the exact order. Instead, various steps may be processed in reverse order or simultaneously. Meanwhile, other operations may be added to these procedures, or a certain step or steps may be removed from these procedures.

Continental shale differs significantly from marine shale, with a higher clay content, lower matrix brittleness, and more complex interlayer lithology, making it difficult to form complex fracture networks. Current close-cut fracturing techniques increase fracture density but exacerbate inter-fracture stress interference, resulting in uneven fracture growth and suboptimal reservoir modification. The internal rock types and mechanical properties of continental shale vary widely; rock hardness, elastic modulus, brittleness, and porosity can differ significantly across layers. Additionally, the uneven distribution of ground stress, with significant differences in horizontal and vertical stress, complicates fracturing design. Moreover, shale layers often contain interspersed layers of rocks like marl or siltstone, which interrupt the continuity of the shale and act as natural barriers, hindering fracture extension through these hard or low-permeability layers, thus reducing overall reservoir connectivity and permeability. Consequently, during hydraulic fracturing of continental shale reservoirs, fractures fail to efficiently propagate laterally and vertically, limiting contact with more reservoir rock, restricting the modified reservoir volume, and leading to lower than expected production of gas or oil from fractured wells, thereby decreasing economic returns.

In view of the foregoing, some embodiments of the present disclosure provide a method for optimization of fracture parameters of segmented multi-cluster fracturing in a horizontal well of a continental shale, which fully takes into account special features of the continental shale, and then carries out the optimization of the perforation parameters, and at the same time, determines the overall design of the engineering parameters. This method is conducive to improving the production and effect of segmented multi-cluster fracturing.

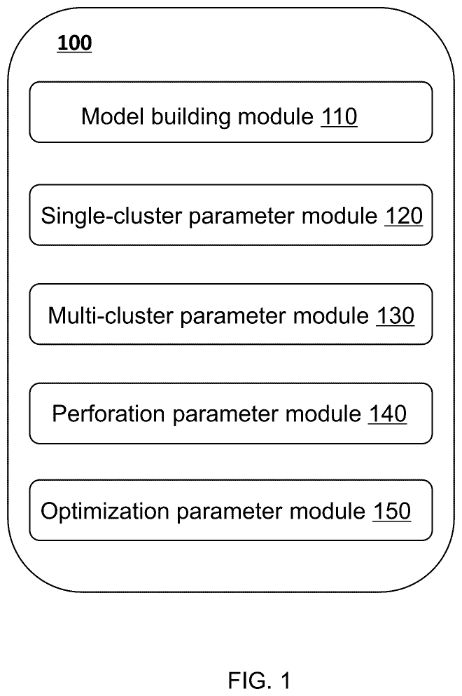

FIG. 1 is a schematic structural diagram illustrating a system for optimization of fracture parameters of segmented multi-cluster fracturing in a horizontal well of a continental shale according to some embodiments of the present disclosure.

As shown in FIG. 1, a system 100 for optimization of fracture parameters of segmented multi-cluster fracturing in a horizontal well of a continental shale may include a model building module 110, a single-cluster parameter module 120, a multi-cluster parameter module 130, a perforation parameter module 140, and an optimization parameter module 150.

In some embodiments, the system 100 for optimization of fracture parameters of segmented multi-cluster fracturing in a horizontal well of a continental shale (hereinafter referred to as the system 100) may be applied in the field of shale gas development, particularly in the extraction of shale gas and shale oil resources. For example, the system 100 may be used to design and optimize hydraulic fracturing in the later stages of oil and gas exploration and early stages of development in order to increase oil and gas production and recovery.

The model building module 110 is configured to establish a fracture extension model.

In some embodiments, the model building module 110 is further configured to establish a coupling control equation based on an effective stress matrix, a pore pressure, an imaginary strain rate matrix, an imaginary velocity vector, a surface force vector, and a body force vector; establish a mass conservation equation based on a change rate of rock volume, a fluid density, a porosity, an external normal direction vector of a surface, and a flow rate of fluid in rock; and establish a flow velocity equation based on the fluid density, a space vector, a gravitational acceleration vector, a rock skeleton permeability tensor, a pore pressure, and the flow rate of fluid in rock.

In some embodiments, the modeling building module 110 is further configured to: establish a fluid tangential flow equation based on a tangential flow, a pressure drop gradient in a length of the cohesive unit, the slit width, and the viscosity of the fracturing fluid; establish an equation for the conservation of fluid mass based on the rate of change of the slit width, the dispersion of the tangential flow rate, the normal flow rate flowing into the upper and lower surfaces of the cohesive unit, the Dirac function, and the injection displacement; establish an equation for the conservation of fluid mass based on the normal flow rate into the upper and lower surfaces of the cohesive unit, the filtration loss coefficient of the upper and lower surfaces of the hydraulic fracture, the pore pressure at the upper and lower surfaces of the hydraulic fracture, and the fluid pressure inside the hydraulic fracture, to establish the filtration loss equation of the fracturing fluid.

In some embodiments, the model building module 110 is further configured to establish a damage equation for a cohesive unit based on a normal stress actually borne by the cohesive unit and a tangential stress actually borne by the cohesive unit in two directions, a maximum tensile resistance capable of being borne by the cohesive unit, and a maximum shear resistance in two directions capable of being borne by the cohesive unit; establish a stiffness degradation criterion equation for evolution of unit damage based on a normal stress of the cohesive unit under a first pre-determined condition, a tangential stress of the cohesive unit under the first pre-determined condition, a displacement at a time of initial damage, a displacement when a unit is completely destroyed, a maximum displacement attained in a loading process, and a damage factor.

In some embodiments, the model building module 110 is further configured to establish a fluid energy conservation equation based on a fluid pressure at an injection node, the fluid pressure at an injection node, a fluid pressure at an entrance of each cluster of the multi-cluster hydraulic fracture, a wellbore pressure drop friction, an aperture pressure drop friction, and a count of perforation clusters within a single fracturing section; establish a wellbore friction pressure drop equation based on an elevation difference between two nodes of a tubular unit, a fluid density, a gravitational acceleration, a flow rate of fluid within the tubular unit, a loss coefficient, and a directional loss coefficient; establish an perforation aperture friction pressure drop equation based on the fluid density, the flow rate of fluid within the tubular unit, a pressure loss coefficient of a connecting unit.

The single-cluster parameter module 120 is configured to perform a layer-crossing extension simulation of a single-cluster hydraulic fracture based on at least one injection displacement and at least one fracturing fluid viscosity to determine engineering parameters for the single-cluster hydraulic fracture.

In some embodiments, the single-cluster parameter module 120 is further configured to determine the engineering parameters for the single-cluster hydraulic fracture based on a minimum layer-crossing displacement and a minimum layer-crossing viscosity satisfying a second predetermined condition.

The multi-cluster parameter module 130 is configured to determine engineering parameters for a multi-cluster hydraulic fractures based on the engineering parameters for the single-cluster hydraulic fracture.

In some embodiments, the engineering parameters for the single-cluster hydraulic fracture include at least one of an optimal injection displacement or an optimal fracturing fluid viscosity for the single-cluster hydraulic fracture, and the multi-cluster parameter module 130 is further configured to obtain the engineering parameters for the multi-cluster hydraulic fractures by performing an amplification processing on the at least one of the optimal injection displacement or the optimal fracturing fluid viscosity for the single-cluster hydraulic fracture.

In some embodiments, the multi-cluster parameter module 130 is further configured to determine an amplification factor based on a count of perforation clusters within a single fracturing section, amplifying the optimal injection displacement for the single-cluster hydraulic fracture, determining an optimal injection displacement for the multi-cluster hydraulic fractures, and using the optimal fracturing fluid viscosity for the single-cluster hydraulic fracture as an optimal fracturing fluid viscosity for the multi-cluster hydraulic fractures; or determine the amplification factor based on the count of perforation clusters within the single fracturing section, amplifying the optimal injection displacement and the optimal fracturing fluid viscosity of the single-cluster hydraulic fracture, respectively, and obtaining the optimal injection displacement and the optimal fracturing fluid viscosity of the multi-cluster hydraulic fractures.

The perforation parameter module 140 is configured to determine, based on the engineering parameters of the multi-cluster hydraulic fractures, an equilibrium expansion index and a ground construction pressure for the multi-cluster hydraulic fractures corresponding to at least one perforation parameter.

In some embodiments, the perforation parameter module 140 is further configured to determine the equilibrium expansion index based on an average inlet flow of the multi-cluster hydraulic fractures, a maximum inlet flow and a minimum inlet flow in each cluster of the multi-cluster hydraulic fractures; determine, based on a perforation aperture diameter, a count of a plurality of perforations in a single perforation cluster, a fluid density, and an empirical coefficient, an aperture friction pressure drop corresponding to each of the plurality of perforations in the single perforation cluster; determine a wellbore fluid flow friction based on a hydraulic friction coefficient, a wellbore length, a wellbore diameter, a fracturing fluid flow rate, and the fluid density; and determine the ground construction pressure based on the aperture friction pressure drop, the wellbore fluid flow friction, the fluid density, a plumb depth of a horizontal well, a hydraulic fracture extension pressure gradient, and a gravitational acceleration.

The optimization parameter module 150 is configured to filter an optimal perforation parameter based on the equilibrium expansion index and the ground construction pressure.

In some embodiments, the optimization parameter module 150 is further configured to filter the perforation parameter whose equilibrium expansion index and ground construction pressure satisfy a third predetermined condition as the optimal perforation parameter.

Further description of the model building module 110, the single-cluster parameter module 120, the multi-cluster parameter module 130, the perforation parameter module 140, and the optimization parameter module 150 may be found in the related descriptions later.

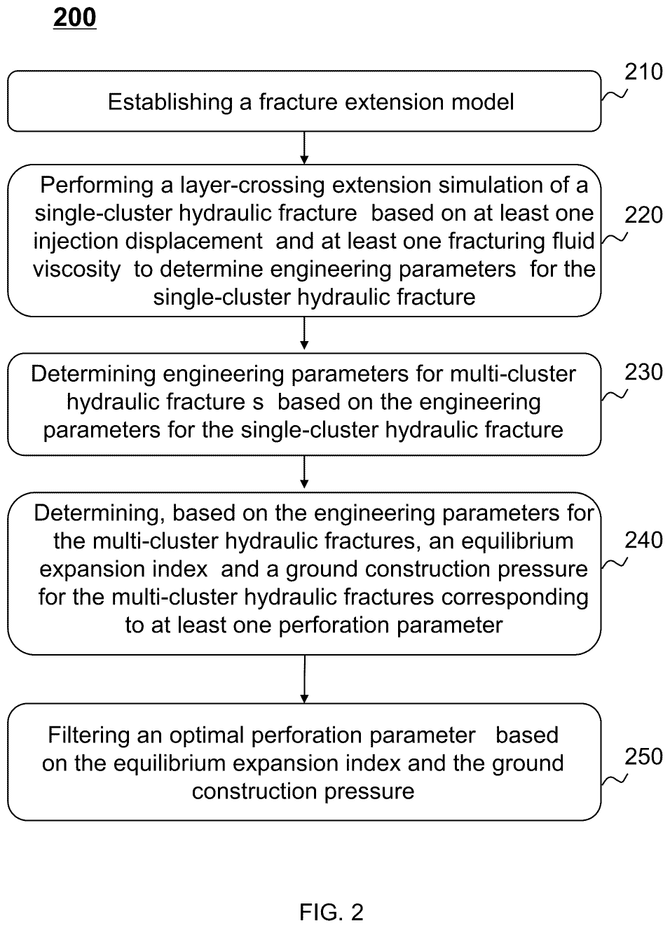

In some embodiments, the model building module 110, the single-cluster parameter module 120, the multi-cluster parameter module 130, the perforation parameter module 140, and the optimization parameter module 150 are integrated into a processor, and a process 200 in FIG. 2 below may be considered to be executed by the processor.

It is to be noted that the above description of the system 100 and its modules is provided only for descriptive convenience, and does not limit the present disclosure to the scope of the cited embodiments. It is to be understood that for a person skilled in the art, after understanding the principle of the system, may arbitrarily combine the individual modules or form a sub-system to be connected to the other modules without departing from the principle. For example, the individual module may share a common storage module, and the individual module may each have their own storage module. Such morphisms are within the scope of protection of the present disclosure.

FIG. 2 is an exemplary flowchart illustrating a method for optimization of fracture parameters of segmented multi-cluster fracturing in a horizontal well of a continental shale according to some embodiments of the present disclosure;

In some embodiments, the process 200 may be realized based on a processor of the system for optimization of fracture parameters of segmented multi-cluster fracturing in a horizontal well of a continental shale. As shown in FIG. 2, the process 200 includes the following steps.

Step 210, establishing a fracture extension model.

The fracture extension model is a model that describes and predicts a process of formation and extension of fractures in a solid material (e.g., rock, etc.).

In some embodiments, the fracture extension model may be a numerical model, and may also be a machine learning model.

In some embodiments, inputs of the fracture extension model may include geological parameters, fluid parameters, or the like. The geological parameters include, but are not limited to, an elasticity modulus, a Poisson ratio, a tensile strength, a rock type, and a formation pressure. The fluid parameters include, but are not limited to, an injection displacement, fracturing fluid properties (e.g., a viscosity, a filtration loss coefficient), etc.; and outputs of the fracture extension model may include a fracture geometry and an extension trajectory, etc. The fracture geometry includes a fracture length, width, or other dimension.

In some embodiments, the fracture extension model is performed by numerical simulation manners such as Finite Element Analysis (FEA), Extended Finite Element Method (XFEM), or Cohesive Zone Model (CZM) to perform a fracture extension simulation to simulate a dynamic behavior of fractures.

In some embodiments, taking into account effects of large lithology and stress differences between layers of the continental shale, the development of compartmentalized interlayers, interstitial stress disturbances, and dynamic distribution of an inter-cluster flow, the processor may introduce a pipe flow unit based on a finite element manner and cohesive zone model to establish a fully fluid-solid coupling numerical model of fracture extension in multi-cluster fracturing of horizontal wells in the continental shale gas.

The pipe flow unit is configured to simulate a flow of a fluid through a pipe or a fracture. In some embodiments, the pipe flow unit may be a separate model or submodel used in conjunction with finite element analysis (FEA) or cohesive zone model (CZM). In some embodiments, the pipe flow unit may be designed as a mathematical model in finite element analysis to simulate fluid flow paths and pressure distributions.

The fluid-solid coupling refers to a process for synchronously considering a mechanical behavior of a solid material (e.g., rock) and a flow feature of a fluid (e.g., a fracturing fluid).

In some embodiments, the processor may perform a fracture extension simulation based on finite element analysis (FEA) or cohesive zone model (CZM) via simulation software (e.g., ABAQUS and FLAC3D), and the processor may embed the cohesive unit at the fracture in the FEA for simulating the mechanical behavior and damage an evolution process of the fracture.

In some embodiments, the fracture extension model includes a fluid-solid coupling control equation.

The fluid-solid coupling control equation is used to describe fluid-solid interactions.

In some embodiments, the fluid-solid coupling control equation may include a coupling control equation, a mass conservation equation, and a flow velocity equation.

The coupling control equation is a mathematical equation or mathematical model used to describe the interaction between the deformation of a solid skeleton of the rock and the fluid flow in a fracture space during hydraulic fracturing.

The mass conservation equation is a mathematical equation or mathematical model that describes the process of mass conservation during fluid flow in the presence of deformations or a wide range of continuous medium changes.

The flow velocity equation is a mathematical equation or mathematical model used to describe the flow features of the fluid in rock pores.

In some embodiments, the processor may establish the coupling control equation based on an effective stress matrix, a pore pressure, an imaginary strain rate matrix, an imaginary velocity vector, a surface force vector, and a body force vector.

The effective stress matrix is an actual stress on the solid skeleton in the rock.

The pore pressure is a sum of a pressure of the fluid in the rock pores and a stress in the formation.

A unit matrix is a square matrix with elements on the diagonal being 1 and off-diagonal elements being 0. The unit matrix is used to represent constant transformations in mathematics.

The imaginary strain rate matrix is used to characterize a virtual deformation rate of the rock.

The imaginary velocity vector represents a virtual velocity of the fluid in the rock pores.

In some embodiments, the effective stress matrix may be used as an unknown quantity in the coupling control equation, and the processor may obtain the effective stress matrix by solving the coupling control equation. In some embodiments, the pore pressure, the imaginary strain rate matrix, and the imaginary velocity vector may be used as known quantities of the coupling control equation, and the processor may determine the imaginary strain rate matrix and the imaginary velocity vector according to the deformation of the solid skeleton based on the fracture extension simulation.

The surface force vector is a vector of a force acting on the surface of the rock.

The body force vector is a vector of a force acting on a volume of the rock. For example, the body force vector includes gravity.

In some embodiments, the surface force vector and the body force vector may be known quantities for the coupling control equation, and the processor may determine the surface force vector and the body force vector based on a pre-defined boundary condition.

In some embodiments, the processor may establish the coupling control equation based on the effective stress matrix, the pore pressure, the imaginary strain rate matrix, the imaginary velocity vector, the surface force vector, and the body force vector in a plurality of ways. For example, the processor may compute a difference between effective stress matrix at all points in the entire volume of the rock minus the product of the pore pressure and the unit matrix, and compute a volume integral of a product of that difference and the imaginary strain rate matrix, and determine strain energy stored in the volume of the rock due to deformation of the rock skeleton and action energy of the fluid pressure on the solid skeleton; calculate a first momentum change due to a surface force based on an area integral of a product of the surface force vector and the imaginary velocity vector; calculate a second momentum change due to a volumetric force based on a volume integral of a product of the body force vector and the imaginary velocity vector; and establish the coupling control equation based on the strain energy, the action energy, the first momentum change, and the second momentum change.

Exemplarily, the coupling control equation is shown in equation (1):

$${\int }_{V} ( \overline{σ} - {p}_{w} I ) \cdot {δ}_{ε} {d}_{V} = {\int }_{S} t \cdot {δ}_{v} {d}_{S} + {\int }_{V} f \cdot {δ}_{v} {d}_{V} , \qquad ( 1 )$$

wherein σ is the effective stress matrix in Pa, p_{w} is the pore pressure in Pa, I is the unit matrix in dimensionless units, δ_{ε} is the imaginary strain rate matrix in s⁻¹, δᵥ is the imaginary velocity vector in m/s; t is the surface force vector in N/m²; f is the body force vector in N/m³, the volume of the rock is V, and the surface area of the rock is S.

The volume of the rock and the surface area of the rock may be obtained based on manual input or a storage module.

In some embodiments, the processor may establish a mass conservation equation based on a change rate of rock volume, a fluid density, a porosity, an external normal direction vector of a surface, and a flow rate of fluid in rock.

The change rate of rock volume is used to characterize a rate at which the volume of the rock changes over time. In some embodiments, the processor may determine the change rate of rock volume based on a ratio of the volume of the rock after deformation to the volume before deformation.

The fluid density is a density of fluid in the rock.

The porosity is a proportion of a pore volume to a total volume in the rock.

The external normal direction vector of the surface is a direction vector that represents an outer normal of a rock surface.

The flow rate of fluid in rock includes a velocity component of the fluid as it flows inside the rock in a direction of each coordinate axis.

In some embodiments, the change rate of rock volume, the fluid density, and the external normal direction vector of the surface may be used as the known quantities of the mass conservation equation; and the pore pressure and the flow rate of fluid in rock may be used as the unknown quantities of the mass conservation equation.

In some embodiments, the processor may obtain the change rate of rock volume based on a fracture extension simulation; obtain the fluid density and the porosity based on a manual input or storage module; determine, based on a pre-defined boundary condition, the external normal direction vector of the surface; and determine the pore pressure and the flow rate of fluid in rock by jointly solving the flow velocity equation and the mass conservation equation.

In some embodiments, the processor may establish a mass conservation equation based on the change rate of rock volume, the fluid density, the porosity, the external normal direction vector of the surface, and the flow rate of fluid in rock. For example, the processor may calculate a product of the change rate of rock volume, the fluid density, and the porosity, perform a volume integral based on a product of a derivative of the product of the change rate of rock volume, the fluid density, and the porosity with respect to time and an inverse of the change rate of rock volume to determine a change in fluid mass (i.e., a first mass) due to a change in rock volume; based an area integral of a product of the fluid density, the porosity, the external normal direction vector of the surface, and the flow rate of fluid in rock, calculate a mass of fluid passing through the rock surface per unit time (i.e., a second mass); and determine the mass conservation equation based on the first mass and the second masse.

Exemplarily, the mass conservation equation is shown in equation (2):

$${\int }_{V} \frac{1}{J} \frac{d}{dt} ( J {ρ}_{w} {φ}_{w} ) {d}_{V} + {\int }_{S} {ρ}_{w} {φ}_{w} {n}^{T} \cdot {v}_{w} {d}_{S} = 0 , \qquad ( 2 )$$

wherein J is the change rate of rock volume in dimensionless units, ρ_{w} is the fluid density in kg/m³; φ_{w} is the porosity in dimensionless units, n^{T} is an external normal direction vector of a surface S in dimensionless units; and v_{w} is the flow rate of fluid in rock.

In some embodiments, the processor may establish the flow velocity equation based on the fluid density, a space vector, a gravitational acceleration vector, a rock skeleton permeability tensor, the pore pressure, and the flow rate of fluid in rock.

The space vector is a vector used in three-dimensional space to define positions of all points within the rock in the fracture extension model.

The gravitational acceleration vector is a vector of gravitational acceleration near the surface of the earth. The gravitational acceleration usually is taken to be 9.8 m/s².

The rock skeleton permeability tensor is used to characterize the ability of the rock to allow fluid to pass through. In some embodiments, the rock skeleton permeability tensor is anisotropic, indicating a difference in permeability of the rock medium in different directions.

In some embodiments, the fluid density, the space vector, the gravitational acceleration vector, and the rock skeleton permeability tensor may be known quantities of the flow velocity equation; and the pore pressure and the flow rate of fluid in rock may be unknown quantities of the flow velocity equation.

In some embodiments, in the fracture extension simulation, the processor may determine the space vector by establish a geometric grid created with each grid point having a corresponding spatial coordinate; and determine the gravitational acceleration vector and the rock skeleton permeability tensor via a manual input or a storage module.

In some embodiments, the processor may establish the flow velocity equation based on the fluid density, the space vector, the gravitational acceleration vector, the rock skeleton permeability tensor, the pore pressure, and the flow rate of fluid in rock by multiple ways. For example, the processor may establish the flow velocity equation based on the fluid density, the space vector, the gravitational acceleration vector, the rock skeleton permeability tensor, the pore pressure, and the flow rate of fluid in rock by means of Darcy's law.

Exemplarily, the flow velocity equation is shown in equation (3):

$${v}_{w} = - \frac{1}{{φ}_{w} g {ρ}_{w}} k ( \frac{\partial {p}_{w}}{\partial x} - {ρ}_{w} g ) , \qquad ( 3 )$$

wherein x is the space vector in meters; g is the gravitational acceleration vector in m/s²; and k is the rock skeleton permeability tensor in m/s.

According to some embodiments of the present disclosure, the physical phenomena during fracture extension can be more realistically reflected by considering both solid mechanics (rock deformation) and hydrodynamics (fluid flow) processes; and the fluid-solid coupling control equation can be used to more accurately predict fracture extension paths, velocities, and modes, as well as the changes in the fluid flow caused by the fracture extension.

In some embodiments, the fracture extension model includes an in-seam fluid flow equation.

The in-seam fluid flow equation is used to describe a flow behavior of a fluid inside a fracture or network of fractures.

In some embodiments, the in-seam fluid flow equation includes a fluid tangential flow equation, a fluid mass conservation equation, and a fracturing fluid filtration loss equation.

The fluid tangential flow equation is a mathematical equation or mathematical model that describes the flow of a fluid along a tangential direction in a tubular, fracture, or other flow path.

The fluid mass conservation equation is a mathematical equation or mathematical model that describes a mass conservation during a fluid flow in an absence of significant volumetric deformation.

The fracturing fluid filtration loss equation is a mathematical equation or mathematical model that describes a permeation of fracturing fluid from the fracture to the surrounding formation during hydraulic fracturing.

In some embodiments, the processor may establish the fluid tangential flow equation based on the tangential flow rate, a pressure drop gradient along a length direction of a cohesive unit, a fracture width, and the fracturing fluid viscosity.

The tangential flow refers to a flow of fluid along a length direction of the fracture, i.e., a volume of fluid flowing through a fracture cross-section per unit time.

The pressure drop gradient along the length direction of the cohesive unit indicates a variation of a fluid pressure within the hydraulic fracture with respect to a fracture length.

The fracture width is a width of the fracture.

The fracturing fluid viscosity refers to a viscosity of the fracturing fluid, which determines a magnitude of internal friction in the flow of the fracturing fluid and affects a resistance to fluid flow and a required pressure.

In some embodiments, the pressure drop gradient in the length direction of the cohesive unit and the fracturing fluid viscosity may be used as known quantities of the fluid tangential flow equation; and the fracture width and the tangential flow may be used as unknown quantities of the fluid tangential flow equation.

In some embodiments, the processor may obtain the fracturing fluid viscosity based on a manual input or a storage module; the processor may determine, based on a fracture extension simulation, the pressure difference between a fracture inlet and a fracture outlet, and the length of the fracture, to determine the pressure drop gradient in a length direction of a cohesive unit; the processor may jointly solve the fluid tangential flow equation and the fluid mass conservation equation to determine the fracture width and the tangential flow.

In some embodiments, the processor may establish the fluid tangential flow equation based on the tangential flow, the pressure drop gradient in a length direction of a cohesive unit, the fracture width, and the fracturing fluid viscosity by multiple ways. For example, the processor may calculate a ratio of a third power of the fracture width to the fracturing fluid viscosity and determine the tangential flow based on an opposite of a product of the ratio and the pressure drop gradient in a length direction of a cohesive unit.

Exemplarily, the fluid tangential flow equation is shown in equation (4):

$$q = - \frac{{w}^{3}}{12 μ} ∇ p , \qquad ( 4 )$$

wherein q is the tangential flow in m³/s; ∇p is the pressure drop gradient in the length direction of the cohesive unit in Pa/m; w is the fracture width in m; and μ is the fracturing fluid viscosity in Pa·s.

In some embodiments, the processor may establish the fluid mass conservation equation based on a change rate of the fracture width, a divergence of the tangential flow, a normal flow into an upper surface of the cohesive unit, a normal flow into a lower surface of the cohesive unit, a Dikla function, and the injection displacement.

The change rate of the fracture width is a derivative of the fracture width with respect to time. The divergence of the tangential flow is a change rate of the fluid flow along the length of the fracture, i.e., a difference in the rate at which fluid flows into and out of a certain section of the fracture.

The normal flow into the upper surface of the cohesive unit and the normal flow into the lower surface of the cohesive unit represent a normal (perpendicular to a fracture surface) flow of fluid into or out of the fracture through \ upper or lower fracture boundaries, respectively.

The Dikla function is used to represent a source or sink concentrated at a point.

The injection displacement is a rate at which the fracturing fluid is pumped into the formation.

In some embodiments, the normal flow into the upper surface of the cohesive unit, the normal flow into the lower surface of the cohesive unit, the Dikla function, and the injection displacement may be used as known quantities for the fluid mass conservation equation; and the change rate of the fracture width and the divergence of the tangential flow may be used as unknown quantities for the fluid mass conservation equation.

In some embodiments, the processor may obtain the injection displacement based on a manual input or a storage module.

In some embodiments, the processor may establish the fluid mass conservation equation based on the change rate of the fracture width, the divergence of the tangential flow, the normal flow into an upper surface of the cohesive unit, the normal flow into a lower surface of the cohesive unit, the Dikla function, and the injection displacement by multiple ways. For example, the processor may obtain an instantaneous injected or withdrawn fluid flow based on the change rate of the fracture width, the divergence of the tangential flow, and the normal flow into the upper surface of the cohesive unit, the normal flow into the lower surface of the cohesive unit in various combinations (e.g., summation, weighted summation, etc.). In some embodiments, the processor may determine the instantaneous injected or withdrawn fluid flow based on a product of the Dikla function and the injection displacement.

Exemplarily, the fluid mass conservation equation is shown in equation (5):

$$\frac{{\partial }_{w}}{{\partial }_{t}} + ∇ \cdot q + ( {q}_{t} + {q}_{b} ) = Q ( t ) δ ( x , y ) , \qquad ( 5 )$$

wherein q is the tangential flow in m³/s; ∇·q is a divergence of q; w is the fracture width in m; qₜ is the normal flow into the upper surface of the cohesive unit in m³/s, q_{b} is the normal flow into the lower surface of the cohesive unit in m³/s, Q(t) is a source term, which represents a rate of external supply or extraction of fluid inside the fracture, and δ(x, y) is the Dikla function, which is used to represent a spatial distribution of the source term and usually has a nonzero value at a specific location (e.g., a point in the fracture) and zero at other locations.

In some embodiments, the processor may establish a fracturing fluid filtration loss equation based on the normal flow into the upper surface of the cohesive unit, the normal flow into the lower surface of the cohesive unit, a filtration loss coefficient of an upper surface of a hydraulic fracture, a filtration loss coefficient of a lower surface of the hydraulic fracture, a pore pressure at the upper surface of the hydraulic fracture, a pore pressure at the lower surface of the hydraulic fracture, and a fluid pressure within the hydraulic fracture.

The filtration loss coefficient of the upper and lower surface is a parameter that measures the ability of the fluid to penetrate from the fracture to surrounding rock, i.e., an amount of fluid filtration loss per unit of pressure difference, per unit of time, and per unit of area.

The pore pressures at the upper surface and the lower surface of the hydraulic fracture indicate pore pressures at a top and a bottom of the fracture, respectively.

The fluid pressure within the hydraulic fracture is a fluid pressure inside the fracture.

In some embodiments, the fluid pressure within the hydraulic fracture, the filtration loss coefficient of the upper surface of the hydraulic fracture, the filtration loss coefficient of the lower surface of the hydraulic fracture, the pore pressure at the upper surface of the hydraulic fracture, and the pore pressure at the lower surface of hydraulic fracture may be used as known quantities for the fracturing fluid filtration loss equation; and the normal flow into the upper surface of the cohesive unit and the normal flow into the lower surface of the cohesive unit may be used as unknown quantities of the fracturing fluid filtration loss equation.

In some embodiments, the processor may obtain the filtration loss coefficient of the upper surface of the hydraulic fracture and the filtration loss coefficient of the lower surface of the hydraulic fracture based on a manual input or a storage module; and the processor may determine the pore pressure at the upper surface and the lower surface of the hydraulic fracture based on the fluid-solid coupling control equation. For a more detailed description of the fluid-solid coupling control equation, see the related description above in FIG. 2. The processor may also obtain the fluid pressure within the hydraulic fracture based on the fracture extension simulation; and determine the normal flow into the upper surface and the lower surface of the cohesive unit by solving the fracturing fluid filtration loss equation.

In some embodiments, the processor may establish a fracturing fluid filtration loss equation in a variety of ways based on normal flows into the upper and lower surfaces of the cohesive unit, filtration loss coefficients of the upper and lower surfaces of the hydraulic fracture, pore pressures at the upper and lower surfaces of the hydraulic fracture, and fluid pressures within the hydraulic fracture.

For example, the processor may calculate a difference between the fluid pressure within the hydraulic fracture and the normal flow into the upper surface of the cohesive unit, and calculate a product (i.e., a first product) of the difference and the filtration loss coefficient of the upper surface of the hydraulic fracture. The processor may calculate a difference between the fluid pressure within the hydraulic fracture and the normal flow into the lower surface of the cohesive unit and calculate a product (i.e., a second product) of the difference and the filtration loss coefficient of the lower surface of the hydraulic fracture. The processor may determine the normal flow into the upper surface of the cohesive unit based on the first product, and determine the normal flow into the lower surface of the cohesive unit based on the second product.

Exemplarily, the fracturing fluid filtration loss equation is shown in equation (6):

$$\{ \begin{matrix}{q}_{t} = {{c}_{t} ( {p}_{f} - {p}_{t} )}_{t} \\ {q}_{b} = {c}_{b} ( {p}_{f} - {p}_{b} )\end{matrix} , \qquad ( 6 )$$

wherein qₜ is the normal flow into the upper surface of the cohesive unit and q_{b} is the normal flow into the lower surface of the cohesive unit in m³/s; cₜ is the filtration loss coefficient of the upper surface of the hydraulic fracture in m³/(Pa·s), c_{b} is the filtration loss coefficient of the lower surface of the hydraulic fracture in m³/(Pa·s); pₜ is the pore pressure at the upper surface of the hydraulic fracture in Pa, and p_{b} is the pore pressure at the lower surface of the hydraulic fracture in Pa; and p_{f} is the fluid pressure within the hydraulic fracture in Pa.

According to some embodiments of the present disclosure, accurate simulation of the fluid tangential flow equation, the fluid mass conservation equation, and the fracturing fluid filtration loss equation, etc., helps predict the pattern of fracture extension, the distribution of fracturing fluid, and a filtration loss, so that prior to actual operation, effective planning and determination of engineering parameters or perforation parameters can reduce uncertainty and improve the success rate of the operation.

In some embodiments, the fracture extension model includes a fracture extension criterion equation.

The fracture extension criterion equation is used to determine and describe whether a fracture will expand and an extent of the extension.

In some embodiments, the fracture extension criterion equation includes a damage equation for the cohesive unit and a stiffness degradation criterion equation for evolution of unit damage.

The damage equation for the cohesive unit is used to describe a process of accumulation of solid material damage at the fracture interface.

The stiffness degradation criterion equation for evolution of unit damage is used to describe a process of decreasing the stiffness of a solid material with increased damage.

In some embodiments, the processor may establish the damage equation for the cohesive unit based on a normal stress and tangential stresses in two directions actually borne by the cohesive unit and a maximum tensile resistance and maximum shear resistances in two directions capable of being borne by the cohesive unit.

The normal stress actually borne by the cohesive unit is a stress component perpendicular to the fracture interface.

The tangential stresses actually borne by the cohesive unit in two directions are stress components in two different directions parallel to the fracture interface. In some embodiments, the two directions include a first direction and a second direction parallel to the fracture interface and opposite to each other.

The maximum tensile resistance capable of being borne by the cohesive unit refers to a maximum tensile stress that the cohesive unit withstands without fracturing, representing the tensile properties of the rock material itself.

The maximum shear resistances in two directions represent maximum shear stresses in the two opposite directions (including the first and second directions) that the cohesive unit withstands without slip, reflecting the shear resistance of the rock material.

In some embodiments of the present disclosure, the normal stress and tangential stresses in two directions actually borne by the cohesive unit and the maximum tensile resistance and maximum shear resistances in two directions capable of being borne by the cohesive unit may be used as known quantities of the damage equation for a cohesive unit. An evaluated value may be used as an unknown quantity for the damage equation of the cohesive unit. The evaluated value may be used to determine whether the fracture is occurred or not. More about the evaluated value may be found in the related description below.

In some embodiments, the processor may obtain the maximum tensile resistance capable of being borne by the cohesive unit and the maximum shear resistance in two directions capable of being borne by the cohesive unit based on a manual input or a storage module; and determine the normal stress actually borne by the cohesive unit and the tangential stresses in two directions actually borne by the cohesive unit by solving the stiffness degradation criterion equation for evolution of unit damage.

In some embodiments, the processor may establish the damage equation for the cohesive unit based on the normal stress and tangential stresses in two directions actually borne by the cohesive unit and the maximum tensile resistance and maximum shear resistances in two directions capable of being borne by the cohesive unit by multiple ways. For example, the processor may calculate a square value (also be referred to as a first square value) of a ratio of a positive value of the normal stress actually borne by the cohesive unit to the maximum tensile resistance capable of being borne by the cohesive unit; calculate a square value (also be referred to as a second square value) of a ratio of a positive value of the tangential stress in the first direction to the maximum shear strength in the first direction; calculate a square value (also be referred to as a third square value) of a ratio of a positive value of the tangential stress in the second direction to the maximum shear strength in the second direction; and obtain the evaluated value based on a combination of the first square value, the second square value, and the third square value in various ways, e.g., summation, weighted summation, etc. When the evaluated value is equal to or greater than 1.0, the processor determines that the fracture occurs.

Exemplarily, the damage equation for the cohesive unit is shown in equation (7):

$${\{ \frac{〈 {σ}_{n} 〉}{{σ}_{n}^{0}} \}}^{2} + {\{ \frac{〈 {τ}_{s} 〉}{{τ}_{s}^{0}} \}}^{2} + {\{ \frac{〈 {τ}_{t} 〉}{{τ}_{t}^{0}} \}}^{2} , \qquad ( 7 )$$

wherein σₙ is the normal stress actually borne by the cohesive unit in Pa, Tₛ and Tₜ are the tangential stresses actually borne by the cohesive unit in two directions in Pa; σₙ^{o} is the maximum tensile resistance capable of being borne by the cohesive unit in Pa, Tₛ^{o} and Tₜ^{o} are the maximum shear resistances in two directions capable of being borne by the cohesive unit in Pa, and the symbol ( ) indicates that the stress takes positive values only.

In some embodiments of the present disclosure, the processor may establish a stiffness degradation criterion equation for evolution of unit damage based on a normal stress of the cohesive unit under a first pre-determined condition, tangential stresses of the cohesive unit under the first pre-determined condition (including a tangential stress in the first direction and a tangential stress in the second direction), a displacement at a time of initial damage, a displacement when a unit is completely destroyed, a maximum displacement attained in a loading process, and a damage factor.

Wherein, the first pre-determined condition refers to a predetermined precondition or an assumed condition. For example, the first pre-determined condition includes a condition in which no damage effect is taken into account (i.e., the material is assumed to be in a fully elastic state) in the current strain state.

An undamaged frontal elastic criterion assumes that a response of the rock material is reversible, i.e., the stresses follow the classical elastic relationship to the strains, and there is no permanent deformation or degradation of the rock material.

A damage factor is used to quantify a degree of damage to the cohesive unit or rock material. In some embodiments, the damage factor takes a value in a range of 0 to 1. When the damage factor is 0, the material is undamaged. When the damage factor is 1, the material is fully damaged and the hydraulic fracture begins to expand. The value of the damage factor gradually increases as the loading and damage process proceeds.

In some embodiments of the present disclosure, the processor may determine the damage factor based on the displacement at the time of initial damage, the displacement when the unit is completely destroyed, and the maximum displacement attained in the loading process. For example, the processor may calculate a difference (referred to as a first difference) between the maximum displacement attained in the loading process and the displacement at the time of initial damage, calculate a difference (referred to as a second difference) between the displacement when the unit is completely destroyed and the displacement at the time of initial damage; and calculate a ratio of the first difference to the second difference and a ratio of the displacement when the unit is completely destroyed to the maximum displacement attained in the loading process; and determine the damage factor based on a product of the above two ratios.

The displacement at the time of initial damage is an amount of displacement at a time when the rock material begins to show small observable damage.

The displacement when the unit is completely destroyed is an amount of displacement that occurs when the rock material reaches a limit of its capacity to withstand, undergoing irreversible damage or complete failure.

The maximum displacement attained in the loading process is a maximum amount of displacement that the rock material actually achieves during a loading or stressing process.

In some embodiments, the normal stress of the cohesive unit under the first pre-determined condition and the tangential stress of the cohesive unit under the first pre-determined condition, the displacement at the time of initial damage, the displacement when the unit is completely destroyed, and the maximum displacement attained in the loading process may be used as known quantities in the stiffness degradation criterion equation for evolution of unit damage; and the normal stress actually borne by the cohesive unit and the tangential stresses in two directions actually borne by the cohesive unit may be used as unknown quantities in the stiffness degradation criterion equation for evolution of unit damage.

In some embodiments of the present disclosure, the processor may obtain the displacement at the time of initial damage and the displacement when the unit is completely destroyed based on a manual input or a storage module. The processor may determine the maximum displacement attained in the loading process, the normal stress and the tangential stress of the cohesive unit under the first pre-determined condition based on the fracture extension simulation. The processor may determine the normal stress actually borne by the cohesive unit and the tangential stresses in two directions actually borne by the cohesive unit by solving the stiffness degradation criterion equation for evolution of unit damage.

In some embodiments, the processor may establish the stiffness degradation criterion equation for evolution of unit damage based on the normal stress of the cohesive unit under the first pre-determined condition, the tangential stress of the cohesive unit under the first pre-determined condition, the displacement at the time of initial damage, the displacement when the unit is completely destroyed, the maximum displacement attained in the loading process, and the damage factor by various ways. For example, the processor may determine a relationship between the normal stress of the cohesive unit under the first pre-determined condition and a first threshold. When the normal stress of the cohesive unit under the first pre-determined condition is greater than or equal to the first threshold, the normal stress actually borne by the cohesive unit is determined based on a product of a difference of a reference value minus the damage factor and the normal stress of the cohesive unit under the first pre-determined condition. When the normal stress of the cohesive unit under the first pre-determined condition is less than the first threshold, the normal stress actually borne by the cohesive unit is determined based on the normal stress of the cohesive unit under the first pre-determined condition. The first threshold may be a system preset value, a system default value, or the like. For example, the first threshold value is 0. The reference value may be determined based on experimentation or experience, e.g., 1.

As another example, the processor may determine the tangential stress actually borne by the cohesive unit in the first direction based on a product of the tangential stress of the cohesive unit in the first direction under the first pre-determined condition and a difference of the reference value minus the damage factor. The processor may determine the tangential stress actually borne by the cohesive unit in the second direction based on a product of the tangential stress of the cohesive unit in the second direction under the first pre-determined condition and a difference of the reference value minus the damage factor.

Exemplarily, the stiffness degradation criterion equation for evolution of unit damage is shown in equation (8):

$$\{ \begin{matrix}\begin{matrix}{σ}_{n} = \{ \begin{matrix}( 1 - D ) \overline{{σ}_{n}} & \overline{{σ}_{n}} \geq 0 \\ \overline{{σ}_{n}} & \overline{{σ}_{n}} < 0\end{matrix} \\ {τ}_{s} = ( 1 - D ) \overline{{τ}_{s}}\end{matrix} \\ {τ}_{t} = ( 1 - D ) \overline{{τ}_{t}}\end{matrix} , D = \frac{{δ}_{f} ( {δ}_{m} - {δ}_{o} )}{{δ}_{m} ( {δ}_{f} - {δ}_{o} )} , \qquad ( 8 )$$

wherein σ̅ₙ is the normal stress of the cohesive unit under the first pre-determined condition, T̅ₛ is the tangential stress of the cohesive unit under the first pre-determined condition in the first direction, T̅ₜ is the tangential stress of the cohesive unit under the first pre-determined condition in the second direction; D is the damage factor in dimensionless units; δ₀ is the displacement at the time of initial damage in meters, δ_{f} is the displacement when the unit is completely destroyed in meters; and δₘ is the maximum displacement attained in the loading process in meters.

In some embodiments of the present disclosure, by establishing the damage equation for the cohesive unit and the stiffness degradation criterion equation for evolution of unit damage, the model is able to capture the whole process of the fracture from its initiation, development, and extension in a more detailed way; the normal and tangential stresses acting on the fracture are taken into account, while the strength limitations of the cohesive unit are also considered, making the simulation of the fracture extension more realistic. Through the simulation of the fracture extension criterion equation, users (e.g., engineers and researchers) can better understand the mechanical mechanism of fracture extension, optimize the fracturing fluid injection strategy and fracture parameters, and reduce unnecessary resource consumption, which has significant value for improving the efficiency of oil and gas extraction, reducing operating costs, and protecting the underground environment.

In some embodiments, the fracture extension model includes a fluid dynamic distribution equation.

The fluid dynamic distribution equation is a mathematical model used to describe a pressure, flow, energy conversion, and distribution laws of a fluid during flow.

In some embodiments, the fluid dynamic distribution equation includes a fluid energy conservation equation, a wellbore friction pressure drop equation, and a perforation aperture friction pressure drop equation.

The fluid energy conservation equation is a mathematical equation or mathematical model used to describe how the total energy (e.g., pressure energy, kinetic energy, and potential energy) of a fluid remains constant in an absence of external input and output during fluid flow.

The wellbore friction pressure drop equation is a mathematical equation or mathematical model used to describe a pressure loss due to friction as a fluid flows through a wellbore.

The perforation aperture friction pressure drop equation is a mathematical equation or mathematical model that describes an additional pressure loss caused by the narrow aperture structure and flow path when fluid enters the formation through a perforation aperture.

In some embodiments, the processor may establish the fluid energy conservation equation based on a fluid pressure at an injection node, a fluid pressure at an entrance of each cluster of multi-cluster hydraulic fractures, a wellbore pressure drop friction, an aperture pressure drop friction, and a count of perforation clusters within a single fracturing section.

The fluid pressure at the injection node is an initial pressure at which the pumped fluid enters the rock. For example, the fluid pressure at the injection node is a fluid pressure located at an outlet of the surface pumping station, reflecting an energy level of the fluid prior to being injected.

The fluid pressure at the entrance of each cluster of the multi-cluster hydraulic fractures is a pressure at which the fluid arrives at an entrance of a particular cluster of fractures after a series of transport processes and is used to assess the equilibrium of the pressure within the fractures and a potential for fracture extension.

The wellbore pressure drop friction is a pressure loss due to friction and turbulence when fluid flows in the wellbore.

The aperture pressure drop friction is a pressure loss due to increased localized resistance as the fluid passes through a perforation aperture (i.e., a small aperture in a fracture).

The count of perforation clusters within the single fracturing section refers to a count of perforation clusters set up in a single hydraulic fracturing section, reflecting a denseness of a fracture network, and affecting the distribution of fluid and the pressure distribution.

In some embodiments, the count of perforation clusters within the single fracturing section and the fluid pressure at the entrance of each cluster of the multi-cluster hydraulic fractures may be used as known quantities of the fluid energy conservation equation; and the fluid pressure at the injection node, the wellbore pressure drop friction, and the aperture pressure drop friction may be used as unknown quantities of the fluid energy conservation equation.

In some embodiments, the processor may obtain the count of perforation clusters within the single fracturing section based on a manual input or a storage module, and the processor may also determine the fluid pressure at the entrance of each cluster of the multi-cluster hydraulic fractures based on the fracture extension simulation; and jointly solve the fluid energy conservation equation, the wellbore friction pressure drop equation, and the perforation aperture friction pressure drop equation to obtain the fluid pressure at the injection node, the wellbore pressure drop friction, and the aperture pressure drop friction.

In some embodiments, the processor may establish the fluid energy conservation equation based on the fluid pressure at the injection node, the fluid pressure at the entrance of each cluster of the multi-cluster hydraulic fractures, the wellbore pressure drop friction, the aperture pressure drop friction, and the count of perforation clusters within the single fracturing section by multiple ways. For example, the processor may obtain the fluid pressure at the injection node based on the fluid pressure at the entrance of each cluster of the multi-cluster hydraulic fractures within the single fracturing section, the wellbore pressure drop friction, and the aperture pressure drop friction in combination in various ways, e.g., summation, weighted summation, etc.

Exemplarily, the fluid energy conservation equation is shown in equation (9):

$${P}_{0} = {\sum }_{i}^{N} {P}_{i} + Δ {P}_{w} + Δ {P}_{pf} , ( I = 1 , 2 , … , , N ) , \qquad ( 9 )$$

wherein P₀ is the fluid pressure at the injection node in MPa; Pᵢ is the fluid pressure at an entrance of an ith cluster of the multi-cluster hydraulic fractures in MPa; ΔP_{w} is the aperture pressure drop friction in MPa; ΔP_{pf} is the wellbore pressure drop friction in MPa; and Nis the count of perforation clusters within the single fracturing section in clusters.

In some embodiments, the processor may establish the wellbore friction pressure drop equation based on an elevation difference between two nodes of a tubular unit, the fluid density, the gravitational acceleration, a flow rate of fluid within the tubular unit, a loss coefficient, and a directional loss coefficient.

The elevation difference between two nodes of the tubular unit is used to reflect a vertical elevation difference between two different nodes in a tubular (e.g., a wellbore, a fracture, or other form of passage). A node may be a start point of a tubular, an end point of a tubular, or an intersection among multiple tubulars, etc.

The gravitational acceleration is the gravitational acceleration of the earth.

The flow rate of fluid within the tubular unit is a flow rate of fluid within a tubular (such as a wellbore, a fracture, or other form of passage).

The loss coefficient is a coefficient that describes an energy loss in a fluid flow.

In some embodiments, the processor may determine the loss coefficient based on a ratio of a friction coefficient of the tubular to a hydraulic diameter. The friction coefficient of the tubular is a coefficient that describes the friction of fluid against a wall of the tubular. The hydraulic diameter is used to calculate an equivalent diameter for fluid flow.

A directional loss coefficient is a coefficient of additional pressure loss due to elbows, valves, or the like, in a tubular or wellbore, reflecting an effect of resistance to a change in fluid direction.

In some embodiments, the elevation difference between two nodes of the tubular unit, the fluid density, the gravitational acceleration, the loss coefficient, and the directional loss coefficient may be used as known quantities for the wellbore friction pressure drop equation; and the wellbore pressure drop friction and the flow rate of fluid within the tubular unit may be used as unknown quantities of the wellbore friction pressure drop equation.

In some embodiments, the processor may obtain the elevation difference between two nodes of the tubular unit, the fluid density, the gravitational acceleration, the friction coefficient and a hydraulic diameter of the tubular, and the directional loss coefficient based on a manual input or a storage module; and obtain the flow rate of fluid within the tubular unit by solving the wellbore friction pressure drop equation.

In some embodiments, the processor may establish the wellbore friction pressure drop equation based on the elevation difference between two nodes of the tubular unit, the fluid density, the gravitational acceleration, the flow rate of fluid within the tubular unit, the loss coefficient, and the directional loss coefficient by various ways. For example, the processor may determine the wellbore pressure drop friction based on a product of the elevation difference between two nodes of the tubular unit, the fluid density, and the gravitational acceleration. As another example, the processor may calculate a sum of the loss coefficient and the directional loss coefficient and calculate a product of the fluid density and a square of the flow rate of fluid within the tubular unit, and determine the wellbore friction pressure drop equation based on the above-mentioned sum and the product.

Exemplarily, the wellbore friction pressure drop equation is shown in equation (10):

$$Δ {P}_{w} = ρ g Δ Z = ( {C}_{L} + {K}_{i} ) \frac{ρ {v}^{2}}{2} , {C}_{L} = \frac{{f}_{L}}{{D}_{h}} , \qquad ( 10 )$$

wherein ΔZ is the elevation difference between two nodes of the tubular unit in meters; ΔZ=Z₁−Z₂, Z₁ and Z₂ are elevations of the two nodes in m; ρ is the fluid density in kg/m³; g is the gravitational acceleration in m/s²; vis the flow rate of fluid within the tubular unit in m/s; C_{L} is the loss coefficient; f_{L} is the friction coefficient of the tubular; Kᵢ is the directional loss coefficient in mm; and Dₕ is the hydraulic diameter or pipe diameter in meters.

In some embodiments, the processor may establish the perforation aperture friction pressure drop equation based on the fluid density, the flow rate of fluid within the tubular unit, and a pressure loss coefficient of a connecting unit.

The pressure loss coefficient of the connecting unit is a pressure loss coefficient at a specific connecting point or component, reflecting an additional resistance of fluid to flow through the connecting point.

In some embodiments, the fluid density, the flow rate of fluid within the tubular unit, and the pressure loss coefficient of the connecting unit may be used as known quantities for the perforation aperture friction pressure drop equation; and the aperture pressure drop friction may be used as an unknown quantity for the perforation aperture friction pressure drop equation.

In some embodiments, the processor may obtain the pressure loss coefficient of the connecting unit based on a manual input or a storage module.

In some embodiments, the processor may establish the perforation aperture friction pressure drop equation based on the fluid density, the flow rate of fluid within the tubular unit, and the pressure loss coefficient of the connecting unit by various ways. For example, the processor may calculate a first product of the fluid density and a square of the flow rate of fluid within the tubular unit, and determine the aperture pressure drop friction based on a product of the first product and the pressure loss coefficient of the connecting unit.

Exemplarily, the perforation aperture friction pressure drop equation is shown in equation (11):

$$Δ {P}_{pf} = K \frac{ρ {v}^{2}}{2} , \qquad ( 11 )$$

wherein K is the pressure loss coefficient of the connecting unit in dimensionless units.

In some embodiments of the present disclosure, the fluid dynamic distribution equation allows users to reduce uncertainty and cost and improve the efficiency of oil and gas extraction by simulating effects of different parameters (e.g., an injection pressure, a fluid flow rate, a count of perforation apertures, fracturing section configuration, etc.) on fracture extension and fluid flow efficiency to guide actual operations and fracture parameters design optimization.

Considering the differences in lithology (e.g., different mineral compositions, pore structures, and brittleness, etc.) and differences in stress (e.g., differences in vertical stress, horizontal stress, etc.) among the continental shale formations, in some embodiments, the processor may assign different rock mechanics parameters, such as a modulus of elasticity, a Poisson's ratio, a tensile strength, and an angle of internal friction, to each reservoir location based on geological data and experimental test results; and assign different geostress parameters, including a magnitude and direction of stress, to each reservoir location based on geological exploration and downhole measurement data.

Step 220, performing a layer-crossing extension simulation of a single-cluster hydraulic fracture based on at least one injection displacement and at least one fracturing fluid viscosity to determine engineering parameters for the single-cluster hydraulic fracture.

The single-cluster hydraulic fracture is a group of fracture clusters formed in an oil or gas formation according to a specific design during hydraulic fracturing.

The layer-crossing extension simulation refers to a numerical simulation of a process of fracture extension and penetration into different strata during hydraulic fracturing.

The engineering parameters for the single-cluster hydraulic fracture are a set of parameters that need to be designed and controlled in order to form the single-cluster hydraulic fracture during hydraulic fracturing. For example, the engineering parameters for the single-cluster hydraulic fracture may include an injection displacement, an injection pressure, an injection rate, a type of fracturing fluid, a fracturing fluid viscosity, or the like, for the single-cluster hydraulic fracture.

Different injection displacements and different fracturing fluid viscosities correspond to different engineering parameters for single-cluster hydraulic fracture.

In some embodiments, the processor may perform the layer-crossing extension simulation of the single-cluster hydraulic fracture based on at least one injection displacement and at least one fracturing fluid viscosity to determine engineering parameters for the single-cluster hydraulic fracture by multiple ways. For example, the processor may use a numerical manner, such as finite element analysis, finite difference manner, or finite volume manner, to perform the fracture extension simulation based on different injection displacements and different fracturing fluid viscosities. The injection displacement and the fracturing fluid viscosity corresponding to a maximum fracture length or a maximum fracture width are used as the engineering parameters for the single-cluster hydraulic fracture.

In some embodiments, the processor may determine the engineering parameters for the single-cluster hydraulic fracture based on a minimum layer-crossing displacement and a minimum layer-crossing viscosity satisfying a second predetermined condition.

The second predetermined condition is a judging condition for screening the engineering parameters for the single-cluster hydraulic fracture. For example, the second predetermined condition includes that the hydraulic fracture completely penetrates a high-quality reservoir. The high-quality reservoir is a stratigraphic section that has a good capacity to store and collect hydrocarbons in hydrocarbon exploration and development.

In some embodiments, the high-quality reservoir may be determined based on a manual input. For example, the high-quality reservoir is a reservoir located at a target depth. In some embodiments, the processor may identify the high-quality reservoir with a high porosity, a high permeability, and a favorable structural location by using core analysis, logging data, or the like.

The minimum layer-crossing displacement is a minimum fracturing fluid injection displacement required to ensure successful fracture penetration and extension into the high-quality reservoir.

The minimum layer-crossing viscosity is a lowest fracturing fluid viscosity that may be guaranteed to allow the fracture to successfully penetrate and extend into the high-quality reservoir.

In some embodiments, the processor may determine the engineering parameters for the single-cluster hydraulic fracture based on the minimum layer-crossing displacement and the minimum layer-crossing viscosity satisfying the second predetermined condition by various ways. For example, the processor may use a numerical simulation manner (e.g., FEA, FDM, or FVM) based on different injection displacements and different fracturing fluid viscosities to simulate the fracture extension under different engineering parameters; filter out the lowest injection displacement and the lowest fracturing fluid viscosity at which the hydraulic fracture completely penetrates through the high-quality reservoir from different engineering parameters as the engineering parameter for the single-cluster hydraulic fracture based on the fracture extension.

According to some embodiments of the present disclosure, it may be ensured that the fracture efficiently penetrates into the high-quality reservoir, maximizing the extension length and width of the fracture by accurately determining the minimum layer-crossing displacement and the minimum layer-crossing viscosity, thereby enhancing a permeability of the reservoir and a hydrocarbon recoverability. At the same time, unnecessary energy consumption, water resources, and chemical additives may be reduced, simultaneously cutting costs and minimizing environmental impact by using the injection displacement and the fracturing fluid viscosity that just meet the requirements.

Step 230, determining engineering parameters for multi-cluster hydraulic fractures based on the engineering parameters for the single-cluster hydraulic fracture.

The multi-cluster hydraulic fractures refer to a plurality of sets of fractures in an oil or gas formation according to a specific design during hydraulic fracturing.

The engineering parameters for the multi-cluster hydraulic fractures are a set of parameters that need to be designed and controlled in order to form the multi-cluster hydraulic fractures during hydraulic fracturing.

In some embodiments, the processor may determine the engineering parameters for the multi-cluster hydraulic fractures based on the engineering parameters for the single-cluster hydraulic fracture by multiple ways. For example, the processor may randomly add or subtract a preset value based on the engineering parameters of the single-cluster hydraulic fracture, and execute this process multiple times to generate a plurality of engineering parameters of the multi-cluster hydraulic fractures. The preset value may be a system preset value or system default value.

In some embodiments, the engineering parameters for the single-cluster hydraulic fracture include an optimal injection displacement and/or an optimal fracturing fluid viscosity for the single-cluster hydraulic fracture, and the processor may obtain the engineering parameters for the multi-cluster hydraulic fractures by performing an amplification processing on the optimal injection displacement and/or the optimal fracturing fluid viscosity for the single-cluster hydraulic fracture.

The optimal injection displacement and the optimal fracturing fluid viscosity are a minimum injection displacement and a minimum fracturing fluid viscosity for fracturing fluid to achieve the layer-crossing extension, respectively.

The amplification processing refers to estimating or deriving the engineering parameters for the multi-cluster hydraulic fractures (i.e., a plurality of fracturing sections constructed simultaneously or sequentially) by adjusting the engineering parameters for the single-cluster hydraulic fracture (e.g., the optimal injection displacement and/or the optimal fracturing fluid viscosity).

In some embodiments, the processor may perform the amplification processing by multiple ways to obtain the engineering parameters for the multi-cluster hydraulic fractures. For example, the processor may increase a total injection displacement proportionally to a count of fracture sections based on the optimal injection displacement for the single-cluster hydraulic fracture. As another example, the processor may increase the minimum fracturing fluid viscosity for the single-cluster hydraulic fracture based on the optimal fracturing fluid viscosity and a preset value. The preset value may be a system preset value, a system default value, or determined based on experimentation or experience.

According to some embodiments of the present disclosure, it may be ensured that the multi-cluster fractures may effectively penetrate the reservoir, and an efficiency and scope of fracture extension may be improved by an appropriate amplification processing; when multi-cluster fractures are present, the flow of fracturing fluid and a pressure distribution may be affected due to mutual interferences (e.g., pressure interferences, fluid scuttling, etc.) among the plurality of hydraulic fractures. Therefore, a moderate upward adjustment of the engineering parameters for the single-cluster hydraulic fracture is required to compensate for a pressure loss and to maintain stable fracture extension.

In some embodiments, the processor may determine an amplification factor based on a count of perforation clusters within a single fracturing section, amplify the optimal injection displacement for the single-cluster hydraulic fracture to determine the optimal injection displacement for the multi-cluster hydraulic fractures, and use the optimal fracturing fluid viscosity for the single-cluster hydraulic fracture as the optimal fracturing fluid viscosity for the multi-cluster hydraulic fractures; or determine the amplification factor based on the count of perforation clusters within a single fracturing section, amplify the optimal injection displacement and the optimal fracturing fluid viscosity of the single-cluster hydraulic fracture, respectively to obtain the optimal injection displacement and the optimal fracturing fluid viscosity of the multi-cluster hydraulic fractures.

The amplification factor is a scaling factor used to adjust the engineering parameters for the single-cluster hydraulic fracture.

The count of perforation clusters within a single fracturing section is the count of perforation clusters within a single fracturing section.

In some embodiments, the processor may determine the amplification factor based on the count of perforation clusters within the single fracturing section by multiple ways. For example, the processor may calculate a product of the count of perforation clusters within the single fracturing section and a first preset value, and determine the amplification factor based on a sum of the product and a second preset value. The first preset value and the second preset value may be a system preset value or a system default value, or the like. Exemplarily, the first preset value is 0.05, and the second preset value is 1. As another example, the count of perforation clusters within the single fracturing section may be used directly as the amplification factor.

In some embodiments, the processor may only amplify the optimal injection displacement for the single-cluster hydraulic fracture. For example, the processor may calculate a product of a first amplification factor and the optimal injection displacement for the single-cluster hydraulic fracture as the optimal injection displacement for the multi-cluster hydraulic fractures; and use the optimal fracturing fluid viscosity for the single-cluster hydraulic fracture as the optimal fracturing fluid viscosity for the multi-cluster hydraulic fractures.

The first amplification factor is A, A=1+0.05N, and N is the count of perforation clusters within a single fracturing section in clusters.

In some embodiments, the processor may simultaneously amplify the optimal injection displacement and the optimal fracturing fluid viscosity for the single-cluster hydraulic fracture. For example, the processor may calculate a product of the optimal injection displacement for the single-cluster hydraulic fracture and the second amplification factor as the optimal injection displacement for the multi-cluster hydraulic fractures; and based on a product of the optimal fracturing fluid viscosity for the single-cluster hydraulic fracture and a third amplification factor, determine the optimal fracturing fluid viscosity of the multi-cluster hydraulic fractures. The second amplification factor and the third amplification factor may be determined based on experimentation or experience. Exemplarily, the second amplification factor is N, and the third amplification factor is B, B=1+0.05N.

In some embodiments, a manner in which the amplification processing is performed may be determined based on a manual input or a priori knowledge. The manner of the amplification processing includes amplifying only the optimal injection displacement for the single-cluster hydraulic fracture or amplifying both the optimal injection displacement and the optimal fracturing fluid viscosity for the single-cluster hydraulic fracture simultaneously.

According to some embodiments of the present disclosure, by reasonably amplifying the engineering parameters of the single-cluster hydraulic fracture, it is possible to quickly adapt to changes in the scale of the construction of the multi-cluster hydraulic fractures, ensure the fracture extension efficiency in a larger area or a more complex geological structure, and increase an overall coverage and production of oil and gas extraction; based on the amplification factor determined based on the count of perforation clusters, it is possible to more accurately calculate the resources required for the construction of the multi-cluster hydraulic fracture (e.g., a total amount of fracturing fluid, proppant, pumping capacity, etc.), avoiding a waste of resource, simultaneously ensuring a continuity and effectiveness of the construction, and reducing the cost.

Step 240, determining, based on the engineering parameters for the multi-cluster hydraulic fractures, an equilibrium expansion index and a ground construction pressure for the multi-cluster hydraulic fractures corresponding to at least one perforation parameter.

The perforation parameter is a parameter of an aperture drilled at a specific location in a wellbore to guide and control a direction of fracture initiation and extension during hydraulic fracturing. For example, the perforation parameter includes a count of perforations, a perforation aperture diameter, a perforation depth, an alignment pattern (linear, staggered, etc.), etc. Exemplarily, the perforation parameter includes that a set of perforation clusters every 3 meters is provided within a fracturing section, and each cluster includes 5 perforations having a perforation diameter of 12.5 mm, the perforation clusters are disposed in a staggered arrangement to enhance lateral extension of the fractures. The count of perforations is a count of perforation apertures within a single perforation cluster.

In some embodiments, the processor may determine the perforation parameter based on a manual input or historical data.

The equilibrium expansion index is a measure of a uniformity and overall coordination of expansion of the multi-cluster hydraulic fractures.

The ground construction pressure is a pressure at which ground pumping equipment injects fracturing fluids into a well.

In some embodiments, the processor may determine, based on the engineering parameters of the multi-cluster hydraulic fractures, the equilibrium expansion index and the ground construction pressure of the multi-cluster hydraulic fractures corresponding to each perforation parameter by multiple ways. For example, the processor may establish a correspondence between different perforation parameters and different equilibrium expansion indexes and ground construction pressures based on historical data and engineering experience.

In some embodiments, the processor may determine the equilibrium expansion index based on an average inlet flow of the multi-cluster hydraulic fractures, a maximum inlet flow and a minimum inlet flow in each cluster of the multi-cluster hydraulic fractures; determine, based on a perforation aperture diameter, the count of a plurality of perforations in a single perforation cluster, the fluid density, and an empirical coefficient, an aperture friction pressure drop corresponding to each of the plurality of perforations in the single perforation cluster; determine the wellbore fluid flow friction based on a hydraulic friction coefficient, a wellbore length, a wellbore diameter, a fracturing fluid flow rate, and the fluid density; and determine the ground construction pressure based on the aperture friction pressure drop, the wellbore fluid flow friction, the fluid density, a plumb depth of a horizontal well, a hydraulic fracture extension pressure gradient, and a gravitational acceleration.

The average inlet flow of the multi-cluster hydraulic fractures is a flow that is equally distributed to each cluster of the multi-cluster hydraulic fractures.

In some embodiments, the processor may determine the average inlet flow for the multi-cluster hydraulic fractures based on the injection displacement of the fracturing fluid divided by a total count of hydraulic fracture clusters.

The maximum inlet flow and the minimum inlet flow in each cluster of the multi-cluster hydraulic fractures are maximum and minimum values of the flow into each cluster of the multi-cluster hydraulic fractures, respectively.

In some embodiments, the processor may determine the maximum inlet flow and the minimum inlet flow in each cluster of the multi-cluster hydraulic fractures based on a manual input. In some embodiments, the processor may perform a fracture extension simulation based on numerical simulation manners, such as the finite element analysis manner, the extended finite element manner, or the cohesive unit manner, to determine the change of the fluid flow of each cluster of the multi-cluster hydraulic fractures over time, and identify the maximum inlet flow and the minimum inlet flow in each cluster of the multi-cluster hydraulic fractures.

In some embodiments, the processor may determine the equilibrium expansion index based on the average inlet flow of the multi-cluster hydraulic fractures, the maximum inlet flow and the minimum inlet flow in each cluster of the multi-cluster hydraulic fractures by various ways. For example, the processor may calculate a difference between the maximum inlet flow in each cluster of the multi-cluster hydraulic fractures and the average inlet flow of the multi-cluster hydraulic fractures, and calculate a first ratio of the difference to the average inlet flow of the multi-cluster hydraulic fractures; calculate a difference between the average inlet flow of the multi-cluster hydraulic fractures and the minimum inlet flow in each cluster of the multi-cluster hydraulic fractures, and calculate a second ratio of the difference to the average inlet flow of the multi-cluster hydraulic fractures; and determine the equilibrium expansion index based on a maximum value of the first ratio and the second ratio.

Exemplarily, the processor may determine the equilibrium expansion index based on equation (12):

$$\{ \begin{matrix}{Q}_{f} = \frac{{Q}_{0}}{N} \\ {δ}_{Q} = max ( \frac{{Q}_{max} - \overline{{Q}_{f}}}{\overline{{Q}_{f}}} , \frac{\overline{{Q}_{f}} - {Q}_{min}}{\overline{{Q}_{f}}} )\end{matrix} , \qquad ( 12 )$$

wherein δ_{Q} is the equilibrium expansion index of the multi-cluster hydraulic fractures in dimensionless units; Q̅_{f} is the average inlet flow of the multi-cluster hydraulic fractures in m³/min; Qₘₐₓ and Qₘᵢₙ are the maximum inlet flow and the minimum inlet flow in each cluster of the multi-cluster hydraulic fractures, respectively, in m³/min; and Q₀ is the injection displacement of the fracturing fluid in m³/min, and N is the count of perforation clusters within the single fracturing section.

The perforation aperture diameter is a size of a hole blown in a wellbore casing and cement layer.

The count of a plurality of perforations in a single perforation cluster is a number of perforations within a specific fracturing cluster (a collection of perforations within a set length or depth).

In some embodiments, the processor may determine the perforation aperture diameter and the count of the plurality of perforations in the single perforation cluster based on a manual input, experimentation, or experience.

The empirical coefficient is a parameter used to adjust predicted results or calculated results to better match actual observations. In some embodiments, the empirical coefficient may be determined based on an experimental data, historical experience, and theoretical analysis. In some embodiments, the empirical coefficient may take a value in a range of 0.5-0.9, with the empirical coefficient taking a value close to 0.5 before abrasion of the perforation aperture, and a value close to 0.9 after abrasion.

In some embodiments, the processor may determine, based on the perforation aperture diameter, the count of the plurality of perforations in the single perforation cluster, the fluid density, and the empirical coefficient, the aperture friction pressure drop corresponding to each of the plurality of perforations in the single perforation cluster by various ways. For example, the processor may determine, by a first predetermined algorithm, the aperture friction pressure drop corresponding to each of the plurality of perforations in the single perforation cluster based on the perforation aperture diameter, the count of the plurality of perforations in the single perforation cluster, the fluid density, and the empirical coefficient.

The first predetermined algorithm refers to an algorithm for determining the aperture friction pressure drop in a perforation cluster. For example, the first predetermined algorithm may be a predetermined equation or mapping relationship, etc. For example, the first predetermined algorithm may be a friction equation.

Exemplarily, the first predetermined algorithm is shown in equation (13):

$$Δ {P}_{pf , n} = 0.807249 \times \frac{ρ}{{n}^{2} {D}_{P}^{4} {C}^{2}} {Q}_{0}^{2} , \qquad ( 13 )$$

wherein ΔP_{pf,n} is the aperture friction pressure drop corresponding to n perforations in a single cluster in MPa; p is the fluid density in kg/m³; Dₚ is the perforation aperture diameter in meters; n is the count of perforations in the single perforation cluster; and C is the empirical coefficient.

The hydraulic friction coefficient is used to characterize a resistance to the flow of fracturing fluid.

The wellbore length is the length of the wellbore.

The wellbore diameter is a diameter inside the wellbore that determines a size of a space through which the fluid passes.

The fracturing fluid flow rate is a speed at which the fracturing fluid moves through the wellbore.

In some embodiments, the processor may obtain the hydraulic friction coefficient, the wellbore length, and the wellbore diameter based on a manual input or a storage module. In some embodiments, the processor may perform the fracture extension simulation based on numerical simulation manners such as finite element analysis, extended finite element manner, or cohesive unit manner to determine the fracturing fluid flow rate. For example, the fracturing fluid flow rate is the flow rate of fluid within the tubular unit as described in FIG. 2 above. For more on the flow rate of fluid within the tubular unit, see the related description in FIG. 2 above.

In some embodiments, the processor may determine the wellbore fluid flow friction based on the hydraulic friction coefficient, the wellbore length, the wellbore diameter, the fracturing fluid flow rate, and the fluid density by various ways. For example, the processor may determine the wellbore fluid flow friction based on the hydraulic friction coefficient, the wellbore length, the wellbore diameter, the fracturing fluid flow rate, and the fluid density by a second predetermined algorithm.

The second predetermined algorithm refers to an algorithm for determining the wellbore fluid flow friction. For example, the second predetermined algorithm may be a predetermined formula or mapping relationship, etc. For example, the second predetermined algorithm may be a Darcy-Weisbach equation.

Exemplarily, the second predetermined algorithm is shown in equation (14):

$$Δ {P}_{wf} = λ \frac{{L}_{w}}{{D}_{w}} \frac{{v}^{2} ρ}{2} , \qquad ( 14 )$$

wherein ΔP_{wf} is the wellbore fluid flow friction in units of MPa; λ is the hydraulic friction coefficient with no factorization; L_{w} is the wellbore length in units of meters; D_{w} is the wellbore diameter in units of meters; v is the fracturing fluid flow rate in units of m/s; and ρ is the fluid density in units of kg/m³.

The plumb depth of the horizontal well is a vertical distance from the ground to the bottom of the horizontal well.

The hydraulic fracture extension pressure gradient is an amount of increase in pressure per unit depth required to extend the fracture further in the formation during hydraulic fracturing. The unit depth may be a system preset value or a system default value.

In some embodiments, the processor may determine the plumb depth of the horizontal well based on a manual input. In some embodiments, the processor may perform the fracture extension simulation based on numerical simulation manners such as the finite element analysis method, the extended finite element manner, or the cohesive force unit manner. Based on the results of the simulation, the processor may compute the hydraulic fracture extension pressure gradient. For example, the hydraulic fracture extension pressure gradient may be a pressure drop gradient in a length direction of the cohesive unit. For more on the hydraulic fracture extension pressure gradient, see the related description above in FIG. 2.

In some embodiments, the processor may determine the ground construction pressure based on the aperture friction pressure drop, the wellbore fluid flow friction, the fluid density, the plumb depth of the horizontal well, the hydraulic fracture extension pressure gradient, and the gravitational acceleration by various ways. For example, the processor may calculate a product of the plumb depth of the horizontal well, the hydraulic fracture extension pressure gradient, and a scaling factor to determine a pressure (referred to as a first pressure) due to fracture extension that is proportional to the pumb depth; determine a pressure (referred to as a second pressure) due to the weight of fluid at the vertical depth based on a product of the fluid density, the plumb depth of the horizontal well, and the gravitational acceleration; and determine the ground construction pressure based on a difference between the first pressure and the second pressure and a sum of the aperture friction pressure drop and the wellbore fluid flow friction.

The scaling factor may be determined based on experimentation or experience. For example, the scaling factor is 0.01.

Exemplarily, the processor may determine the ground construction pressure based on equation (15).

$${P}_{D} = 0.01 {HP}_{h} - ρ gH + Δ {P}_{pf , n} + Δ {P}_{wf} , \qquad ( 15 )$$

wherein His the plumb depth of the horizontal well in units of meters; Pₕ is the hydraulic fracture extension pressure gradient in units of MPa/100 m; and g is the gravitational acceleration.

In some embodiments of the present disclosure, by accurately calculating the equilibrium expansion index, it may be possible to assess whether the expansion of each cluster of fractures is uniform, and thus guide the adjustment of the perforation parameter or the like, to ensure a balanced development of the fracture network, and improve a production capacity and recovery rate of the oil and gas well; by accurately calculating the ground construction pressure, the construction process may be more accurately controlled, reducing unnecessary energy consumption and fracturing fluid usage, and lowering the operation cost.

Step 250, filtering an optimal perforation parameter based on the equilibrium expansion index and the ground construction pressure.

The optimal perforation parameter is a perforation parameter that is ultimately used for actual hydraulic fracturing.

In some embodiments, the processor may filter the optimal perforation parameter based on the equilibrium expansion index and the ground construction pressure by multiple ways. For example, the processor may construct a feature vector based on the equilibrium expansion index and the ground construction pressure corresponding to each type of the perforation parameter, compute a similarity between the feature vector and a standard vector, and take the perforation parameter corresponding to the standard vector with a highest similarity as the optimal perforation parameter. In some embodiments, the processor may calculate a similarity of the two vectors by calculating a Euclidean distance, a cosine similarity, or other similarity measure. The standard vector is a predefined vector.

In some embodiments, the processor may determine a historical equilibrium expansion index and a historical ground construction pressure corresponding to a combination of historical perforation parameters for which fracturing is more effective based on historical data to construct the standard vector.

In some embodiments, the processor may filter the perforation parameter for which the equilibrium expansion index and the ground construction pressure satisfy a third predetermined condition to be the optimal perforation parameter. The perforation parameter includes the count of apertures and the perforation aperture diameter.

The third predetermined condition is an evaluation condition for filtering the optimal perforation parameter. For example, the third predetermined condition includes that the equilibrium expansion index is less than or equal to an equilibrium threshold and the ground construction pressure is less than or equal to a pressure threshold. The equilibrium threshold and the pressure threshold may be determined based on experimentation or experience. Exemplarily, the equilibrium threshold is 0.2, and the pressure threshold is a safety limit pressure. The safety limit pressure is a maximum allowable pressure set to ensure an aperture integrity and stability of a surrounding formation during hydraulic fracturing construction.

In some embodiments, the processor may take the perforation parameter corresponding to the equilibrium expansion index less than or equal to 0.2 and a ground construction pressure less than or equal to the safety limit pressure as the optimal perforation parameter.

In some embodiments of the present disclosure, the optimal perforation parameter (including the count of apertures and the wellbore diameter) screened out can promote a more uniform and effective extension of the fracture, and improve a connectivity and permeability of the fracture network; at the same time, it ensures that the construction operation is carried out within a safe range of pressure, and avoids damage to the equipment or well control accidents that may be caused by overpressure.

In some embodiments of the present disclosure, an accurate fracture extension model is established, and the layer-crossing extension behaviors of single-cluster and multi-cluster hydraulic fractures are accurately predicted by simulation to provide a scientific basis for the determination of the engineering parameters; optimize the injection displacement and the fracturing fluid viscosity to realize effective fracture extension and efficient transformation of oil and gas reservoirs; ensure the uniformity of the fracture network by calculating the equilibrium expansion index, and at the same time, control the ground construction pressure within a safe range to reduce construction risk, ensure the safety of the operation, and contribute to the improvement of perforation efficiency and fracture initiation quality.

It should be noted that the foregoing description of the process in question is for the purpose of exemplification and illustration only and does not limit the scope of application of the present disclosure. For a person skilled in the art, various corrections and changes to the process may be made under the guidance of the present disclosure. However, these corrections and changes remain within the scope of the present disclosure.

One or more embodiments of the present disclosure further provide a device for optimization for fracture parameters of segmented multi-cluster fracturing in a continental shale. The device includes a processor configured for executing the method for optimization of fracture parameters of segmented multi-cluster fracturing in a horizontal well of a continental shale, as described in one or more preceding embodiments.

One or more embodiments of the present disclosure further provide a non-transitory computer-readable storage medium storing computer instructions. After reading the computer instructions in the storage medium, the computer executes the method for optimization of fracture parameters of segmented multi-cluster fracturing in a horizontal well of a continental shale as described in one or more of the above embodiments.

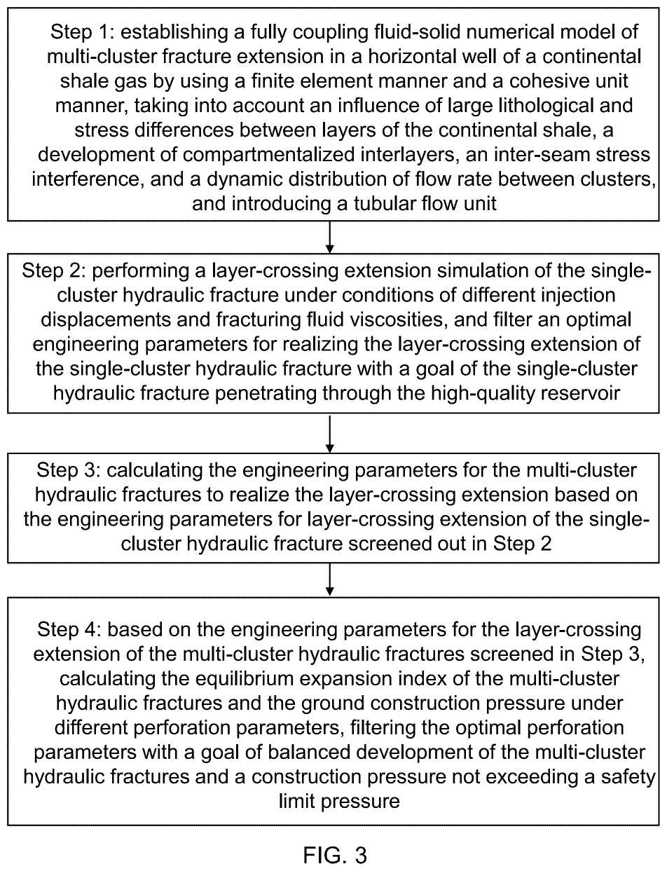

FIG. 3 is an exemplary flowchart illustrating a method for optimization of fracture parameters of segmented multi-cluster fracturing in a horizontal well of a continental shale according to some embodiments of the present disclosure.

According to some embodiments of the present disclosure, the method for optimizing the design of fracture parameters for a segmented multi-cluster fracturing in a horizontal well of a continental shale is further provided, as illustrated in FIG. 3, includes the following steps.

Step 1: establishing a fully coupling fluid-solid numerical model of multi-cluster fracture extension in a horizontal well of a continental shale gas by using a finite element manner and a cohesive unit manner, taking into account an influence of large lithological and stress differences between layers of the continental shale, a development of compartmentalized interlayers, an inter-seam stress interference, and a dynamic distribution of flow rate between clusters, and introducing a tubular flow unit.

In Step 1, specifically, the following steps are included.

S11: establishing a fluid-solid coupling control equation, a coupling control equation of rock solid skeleton deformation and fluid flow, a mass conservation equation of fluid seepage, and a flow velocity equation of fluid within the rock, respectively, as shown in equations (1), (2), and (3):

$${\int }_{V} ( σ - {p}_{w} I ) \cdot {δ}_{ε} {d}_{V} = {\int }_{S} t \cdot {δ}_{v} {d}_{S} + {\int }_{V} f \cdot {δ}_{v} {d}_{V} , \qquad ( 1 )$$

$${\int }_{V} \frac{1}{J} \frac{d}{dt} ( J {ρ}_{w} {φ}_{w} ) {d}_{V} + {\int }_{S} {ρ}_{w} {φ}_{w} {n}^{T} \cdot {v}_{w} {d}_{S} = 0 , \qquad ( 2 )$$

$${v}_{w} = - \frac{1}{{φ}_{w} g {ρ}_{w}} k ( \frac{\partial {p}_{w}}{\partial x} - {ρ}_{w} g ) , \qquad ( 3 )$$

wherein σ is the effective stress matrix in Pa, p_{w} is the pore pressure in Pa, I is the unit matrix in dimensionless units, δ_{ε} is the imaginary strain rate matrix in s⁻¹, δᵥ is the imaginary velocity vector in m/s; t is the surface force vector in N/m²; f is the body force vector in N/m³; J is the change rate of rock volume in dimensionless units, ρ_{w} is the fluid density in kg/m³; φ_{w} is the porosity in dimensionless units, n^{T} is an external normal direction vector of a surface S in dimensionless units; and v_{w} is the flow rate of fluid in rock; and x is the space vector in meters; g is the gravitational acceleration vector in m/s²; and k is the rock skeleton permeability tensor in m/s.

S12: establishing an in-seam fluid flow equation, the fluid tangential flow equation, the fluid mass conservation equation, and the fracturing fluid filtration loss equation, respectively, as shown in equations (4), (5), and (6):

$$q = - \frac{{w}^{3}}{12 μ} ∇ p , \qquad ( 4 )$$

$$\frac{\partial w}{{\partial }_{t}} + ∇ \cdot q + ( {q}_{t} + {q}_{b} ) = Q ( t ) δ ( x , y ) , \qquad ( 5 )$$

$$\{ \begin{matrix}{q}_{t} = {c}_{t} ( {p}_{f} - {p}_{t} ) \\ {q}_{b} = {c}_{b} ( {p}_{f} - {p}_{b} )\end{matrix} \qquad ( 6 )$$

wherein q is the tangential flow in m³/s; ∇p is the pressure drop gradient in the length direction of the cohesive unit in Pa/m; w is the fracture width in m; and μ is the fracturing fluid viscosity in Pa·s; and qₜ is the normal flow into the upper surface of the cohesive unit and q_{b} is the normal flow into the lower surface of the cohesive unit in m³/s; cₜ is the filtration loss coefficient of the upper surface of the hydraulic fracture in m³/(Pa·s), c_{b} is the filtration loss coefficient of the lower surface of the hydraulic fracture in m³/(Pa·s); pₜ is the pore pressure at the upper surface of the hydraulic fracture in Pa, and p_{b} is the pore pressure at the lower surface of the hydraulic fracture in Pa; and p_{f} is the fluid pressure within the hydraulic fracture in Pa.

S13: establishing a fracture extension criterion equation, a damage equation for a cohesive unit, and a stiffness degradation criterion equation for evolution of unit damage, as shown in equations (7) and (8):

$${\{ \frac{〈 {σ}_{n} 〉}{{σ}_{n}^{0}} \}}^{2} + {\{ \frac{〈 {τ}_{S} 〉}{{τ}_{s}^{0}} \}}^{2} + {\{ \frac{〈 {τ}_{t} 〉}{{τ}_{t}^{0}} \}}^{2} , \qquad ( 7 )$$

$$\{ \begin{matrix}\begin{matrix}{σ}_{n} = \{ \begin{matrix}( 1 - D ) \overline{{σ}_{n}} & \overline{{σ}_{n}} \geq 0 \\ \overline{{σ}_{n}} & \overline{{σ}_{n}} < 0\end{matrix} \\ {τ}_{s} = ( 1 - D ) {τ}_{s}\end{matrix} \\ {τ}_{t} = ( 1 - D ) \overline{{τ}_{t}}\end{matrix} , D = \frac{{δ}_{f} ( {δ}_{m} - {δ}_{o} )}{{δ}_{m} ( {δ}_{f} - {δ}_{o} )} , \qquad ( 8 )$$

wherein σₙ is the normal stress actually borne by the cohesive unit in Pa, Tₛ and Tₜ are the tangential stresses actually borne by the cohesive unit in two directions in Pa; σₙ^{o} is the maximum tensile resistance capable of being borne by the cohesive unit in Pa, Tₛ^{o} and Tₜ^{o} are the maximum shear resistances in two directions capable of being borne by the cohesive unit in Pa, and the symbol ( ) indicates that the stress takes positive values only; σₙ^{o} is the tensile resistance of the rock, Tₛ^{o} and Tₜ^{o} are shear resistances of the rock; ōₙ is a stress determined in a normal direction of the cohesive unit according to an undamaged front line elastic criterion under a current strain, T̅ₛ is a stress determined in a tangential direction of the cohesive unit according to the undamaged front line elastic criterion under the current strain; D is a damage factor in dimensionless units and in a range of 0-1, when the damage factor is 0, a material is undamaged, and when the damage factor is 1, the material is fully damaged and the fracture begins to expand; δ₀ is a displacement at a time of initial damage in meters, δ_{f} is a displacement when the cohesive unit is completely destroyed in meters; and δₘ is a maximum displacement attained in a loading process in meters.

S14: establishing a fluid dynamic distribution equation among the multi-cluster hydraulic fractures, and establishing a fluid energy conservation equation, a wellbore friction pressure drop equation, and a perforation aperture friction pressure drop equation, respectively, as shown in equations (9), (10), and (11):

$${P}_{0} = {\sum }_{i}^{N} {P}_{i} + Δ {P}_{w} + Δ {P}_{pf} , ( i = 1 , 2 , … , N ) , ) \qquad ( 9 )$$

$$Δ {P}_{w} = ρ g Δ Z = ( {C}_{L} + {K}_{i} ) \frac{ρ {v}^{2}}{2} , {C}_{L} = \frac{{f}_{L}}{{D}_{h}} , \qquad ( 10 )$$

$$Δ {P}_{pf} = K \frac{ρ {v}^{2}}{2} , \qquad ( 11 )$$

wherein P₀ is the fluid pressure at the injection node in MPa; Pi is the fluid pressure at an entrance of an ith cluster of the multi-cluster hydraulic fractures in MPa; ΔP_{w} is the wellbore pressure drop friction in MPa; ΔP_{pf} is the aperture pressure drop friction in MPa; and Nis the count of perforation clusters within the single fracturing section in clusters; AZ is the elevation difference between two nodes of the tubular unit in meters; ΔZ=Z₁−Z₂, Z₁ and Z₂ are elevations of the two nodes in m; ρ is the fluid density in kg/m³; g is the gravitational acceleration in m/s²; vis the flow rate of fluid within the tubular unit in m/s; C_{L} is the loss coefficient; f_{L} is the friction coefficient of the tubular; L is a length of the tubular in meters, Kᵢ is the directional loss coefficient in mm; and Dₕ is the hydraulic diameter or pipe diameter in meters; and K is the pressure loss coefficient of the connecting unit in dimensionless units.

When considering the lithology and stress differences among continental shale layers, different rock mechanics and geostress parameters are assigned to different layers in conjunction with the real reservoir development features.

Step 2: performing a layer-crossing extension simulation of the single-cluster hydraulic fracture under conditions of different injection displacements and fracturing fluid viscosities, and filtering an optimal engineering parameter for realizing the layer-crossing extension of the single-cluster hydraulic fracture with a goal of the single-cluster hydraulic fracture penetrating through the high-quality reservoir; simulating a layer-crossing extension pattern of the single-cluster hydraulic fracture under the conditions of different injection displacements and fracturing fluid viscosities, and using a minimum injection displacement Q₁ and a fracturing fluid viscosity μ₁ for the single-cluster hydraulic fracture to completely penetrate through the high-quality reservoir as the optimal engineering parameters for the single-cluster hydraulic fracture to realize the layer-crossing extension.

Step 3: calculating the engineering parameters of the multi-cluster hydraulic fractures for realizing the layer-crossing extension based on the engineering parameters for layer-crossing extension of the single-cluster hydraulic fracture filtered in Step 2; performing the fracture extension simulation of the multi-cluster hydraulic fractures under different perforation parameters. Considering the inhibitory effect of the inter-seam stress interference of the multi-cluster hydraulic fractures on the layer-crossing extension of hydraulic fractures, it is necessary to amplify the injection displacement or the fracturing fluid viscosity of the single-cluster hydraulic fracture screened above;

In Step 3, the injection displacement or the fracturing fluid viscosity of the single-cluster hydraulic fracture screened in Step 2 needs to be amplified, and a calculation formula of the engineering parameters for realizing the layer-crossing extension of the multi-cluster hydraulic fractures is shown in equation (16):

$$\{ \begin{matrix}{Q}_{0} = ( 1 + 0.05 N ) {NQ}_{1} \\ {μ}_{0} = {μ}_{1}\end{matrix} or \{ \begin{matrix}{Q}_{0} = {NQ}_{1} \\ {μ}_{0} = ( 1 + 0.05 N ) {μ}_{1}\end{matrix} , \qquad ( 16 )$$

wherein Q₀ is the optimal injection displacement for the multi-cluster hydraulic fractures to realize the layer-crossing extension in, m³/min; N is the count of perforation clusters within a single fracturing section in clusters; Q₁ is the optimal injection displacement for the single-cluster hydraulic fracture to realize layer-crossing extension in m³/min; μ₀ is the optimal fracturing fluid viscosity for the multi-cluster hydraulic fractures to realize layer-crossing extension in mPa·s; and μ₁ is the fracturing fluid viscosity for the single-cluster hydraulic fracture to realize layer-crossing extension in mPa·s.

Step 4: based on the engineering parameters of the multi-cluster hydraulic fractures for realizing the layer-crossing extension filtered in Step 3, calculating the equilibrium expansion index δ_{Q} of the multi-cluster hydraulic fractures and the ground construction pressure P_{D} under different perforation parameters, filtering the optimal perforation parameters based on a goal of balanced development of the multi-cluster hydraulic fractures and the ground construction pressure not exceeding a safety limit pressure. In which, the smaller the index δ_{Q} is, the more uniform the development of each cluster of the multi-cluster hydraulic fractures is; and the larger the construction pressure P_{D} is, the higher the requirements for casing specifications and construction safety are.

In Step 4, the equilibrium expansion index δ_{Q} of the multi-cluster hydraulic fractures and the ground construction pressure P_{D} with different perforation parameters are calculated as shown in equations (12), (13), (14), and (15):

$$\{ \begin{matrix}\overline{{Q}_{f}} = \frac{{Q}_{0}}{N} \\ {δ}_{Q} = max ( \frac{{Q}_{max} - \overline{{Q}_{f}}}{\overline{{Q}_{f}}} , \frac{\overline{{Q}_{f}} - {Q}_{min}}{\overline{{Q}_{f}}} )\end{matrix} \qquad ( 12 )$$

$$\{ \begin{matrix}Δ {P}_{pf , n} = 0.807249 \times \frac{ρ}{{n}^{2} {D}_{P}^{4} {C}^{2}} {Q}_{0}^{2} \\ Δ {P}_{wf} = λ \frac{{L}_{w}}{{D}_{w}} \frac{{v}^{2} ρ}{2} \\ {P}_{D} = 0.01 {HP}_{h} - ρ gH + Δ {P}_{pf , n} + Δ {P}_{wf}\end{matrix} \qquad ( 13 ) , ( 14 ) , and ( 15 )$$

wherein δ_{Q} is the equilibrium expansion index of the multi-cluster hydraulic fractures in dimensionless units; Q̅_{f} is the average inlet flow of the multi-cluster hydraulic fractures in m³/min; Qₘₐₓ and Qₘᵢₙ are the maximum inlet flow and the minimum inlet flow in each cluster of the multi-cluster hydraulic fractures, respectively, in m³/min; and ΔP_{pf,n} is the aperture friction pressure drop corresponding to n perforations in a single cluster in MPa; ΔP_{wf} is the wellbore fluid flow friction in units of MPa; λ is the hydraulic friction coefficient with no factorization; L_{w} is the wellbore length in units of meters; D_{w} is the wellbore diameter in units of meters; v is the fracturing fluid flow rate in units of m/s; and ρ is the fluid density in units of kg/m³; Dₚ is a perforation aperture diameter in meters; n is count of perforations in a single perforation cluster; C is an empirical coefficient with a range of 0.5˜0.9, with the value of C close to 0.5 before the perforation aperture abrasion, and close to 0.9 after the abrasion; P_{D} is the ground construction pressure in MPa; H is the plumb depth of a horizontal well in meters; Pₕ is a hydraulic fracture extension pressure gradient in MPa/100 m; and g is the gravitational acceleration, g≈9.8 m/s².

The perforation parameter satisfying δ_{Q}≤0.2 and P_{D}≤P_{L} is selected as the optimal perforation parameter, and the perforation parameter includes the count of perforations and the perforation aperture diameter.

In some embodiments, taking the Sichuan Basin continental shale gas horizontal well ZX as an example, the shale gas layer of the target section of the well is divided into three subsections and six sublayers, among which \textcircled{5} sublayer is the most optimal and \textcircled{4} sublayer is the second most optimal; \textcircled{1}, \textcircled{4}, and \textcircled{6} sublayers are high-stress layers, and \textcircled{3}-\textcircled{5} sublayers are high-quality reservoir layers. The basic parameters are shown in Table 1.

TABLE 1

| | | | | | Ground stress/MPa | | |
|---|---|---|---|---|---|---|---|
| | | | | | Minimum | | Maximum |
| Layer | Layer | Modulus of | Poisson's | Tensile | horizontal | Vertical | horizontal |
| number | thickness/m | elasticity/GPa | ratio | strength/MPa | geostress | geostress | geostress |
| 6 | 4 | 28 | 0.1 | 6 | 65 | 69.4 | 72 |
| 5 | 8 | 18 | 0.2 | 2 | 60 | 69.8 | 72 |
| 4 | 6 | 24 | 0.12 | 3 | 63 | 70 | 73 |
| 3 | 8 | 21 | 0.14 | 2.5 | 61 | 70.4 | 74 |
| 2 | 6 | 22 | 0.13 | 3 | 62 | 70.8 | 74.5 |
| 1 | 4 | 28 | 0.1 | 6 | 65 | 71 | 75 |

The average vertical depth of the horizontal section of the ZX well is 2800 m, the stratigraphic extensional pressure gradient is 2.6 MPa/100 m, the empirical coefficient C is 0.9, the hydraulic friction coefficient λ is 0.004, the fluid density is 1.05 g/cm³, the wellbore diameter is 139.7 mm, the wall thickness is 12.4 mm, and the safety limit pressure is 80 MPa. Conducting the fracturing design is planned to adopt a method of isodense perforation, with 5-7 clusters of single-section perforation and using a 9.5 mm aperture diameter gun. A design method for optimization of fracturing parameters for segmented multi-cluster fracturing in a horizontal well of a continental shale includes the following steps.

Step 1: establishing a numerical model of fracture extension in multi-cluster fracturing in a fully fluid-solid coupling horizontal well of the continental shale gas by using a finite element manner and the cohesive unit manner, and taking into account effects of large differences in lithology and stress between continental shale layers, a development of compartmentalized interlayers, an interstitial stress interference, and a dynamic distribution of flow among clusters.

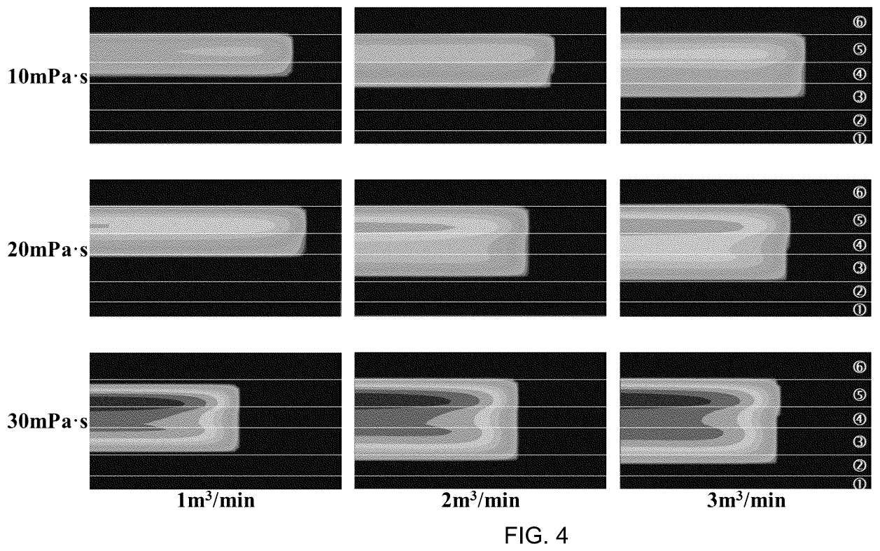

Step 2: performing a layer-crossing extension simulation of the single-cluster fracture under different injection displacements and fracturing fluid viscosities. The fracture extension patterns under various parameters are shown in FIG. 4. FIG. 4 is an exemplary schematic diagram illustrating a layer-crossing extension pattern of a single-cluster hydraulic fracture corresponding to different injection displacements and fracturing fluid viscosities of a ZX well according to some embodiments of the present disclosure. As shown in FIG. 4, hydraulic fractures completely penetrated high-quality reservoirs (\textcircled{3}-\textcircled{5} small layers) when the injection displacement is 2 m³/min and the fracturing fluid viscosity is 20 mPa·s. With a goal of hydraulic fracture completely penetrating the high-quality reservoir layers (\textcircled{3}-\textcircled{5} small layers), the injection displacement of 2 m³/min and the fracturing fluid viscosity of 20 mPa·s are recommended as the optimal engineering parameters for single-cluster fracture to realize the layer-crossing extension.

Step 3: considering inhibitory of interstitial stress interference between multi-cluster fractures on penetration and expansion of the hydraulic fractures, performing an amplification processing on the injection displacement of the single-cluster hydraulic fracture screened in Step 2 is amplified, and keeping the fracturing fluid viscosity constant. The engineering parameters (12.5 m³/min for the injection displacement of 5 clusters of the single segment, 15.6 m³/min for the injection displacement of 6 clusters of the single segment, 18.9 m³/min for the injection displacement of 7 clusters of the single segment, and the fracturing fluid viscosity uniform at 20 mPa·s) for the realization of the layer-crossing extension of the multi-cluster fractures are calculated according to equation (12), and the fracture extension simulation of multi-cluster fractures under different perforation parameters is carried out.

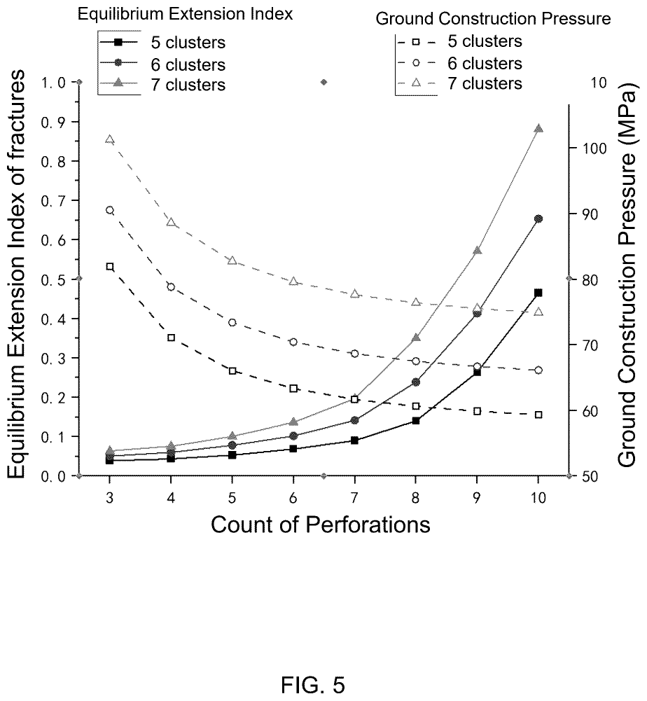

Step 4: calculating the equilibrium expansion index δ_{Q} and the ground construction pressure P_{D} of the multi-cluster hydraulic fractures corresponding to different count of perforations under a single-segment 5-7-cluster fracturing mode as shown in FIG. 5. In accordance with a criteria of δ_{Q}≤0.2 and P_{D}≤80 MPa for preferred perforation parameters, the optimal count of perforations in a single perforation cluster at 5 clusters is recommended to be 4-8 holes; the optimal count of perforations in a single perforation cluster at 6 clusters is recommended to be 4-7 holes; and the optimal count of perforations in a single perforation cluster at 7 clusters is recommended to be 6-7 holes.

FIG. 5 an exemplary schematic diagram illustrating curves of an equilibrium expansion index and a ground construction pressure for the multi-cluster hydraulic fractures corresponding to plans with different count of perforations for single-segment 5-7-cluster fracturing mode in a ZX well according to some embodiments of the present disclosure. As shown in FIG. 5, the horizontal coordinate represents the count of perforations in a single perforation cluster, the vertical coordinate on the left side represents the equilibrium expansion index, and the vertical coordinate on the right side represents the ground construction pressure. The more the count of perforation clusters in a fracturing section, the higher the ground construction pressure; the more the count of perforations in a single perforation cluster, the lower the ground construction pressure; the more the count of perforations in a single perforation cluster, the more the count of perforation clusters in the fracturing section, and the higher the equilibrium expansion index.

For the present embodiment, taking into account the convenience of the implementation of the perforation construction operation, a perforation parameter of 6 perforations for the count of perforations in a single perforation cluster is recommended for the single-segment 5-7-cluster fracturing mode. According to 5-7 clusters of perforation clusters in a single fracturing section, 6 perforations in a single perforation cluster, the workover displacement of 12-19 m³/min, and the pre-fracturing fluid viscosity of 20 mPa·s, a gas release test was carried out after the fracturing in the ZX well, and a daily gas production was 15.4×10⁴ m³, the pressure and production were stable, and the production increase effect of fracturing transformation was significant.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by this disclosure and are within the spirit and scope of the exemplary embodiments of this disclosure.

Moreover, certain terminology has been used to describe embodiments of the present disclosure. For example, the terms “one embodiment,” “an embodiment,” and “some embodiments” mean that a particular feature, structure, or feature described in connection with the embodiment is included in at least one embodiment of the present disclosure. Therefore, it is emphasized and should be appreciated that two or more references to “an embodiment” or “one embodiment” or “an alternative embodiment” in various portions of this specification are not necessarily all referring to the same embodiment. Furthermore, the particular features, structures, or features may be combined as suitable in one or more embodiments of the present disclosure.

Furthermore, the recited order of processing elements or sequences, or the use of numbers, letters, or other designations therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose and that the appended claims are not limited to the disclosed embodiments, but, on the contrary, are intended to cover modifications and equivalent arrangements that are within the spirit and scope of the disclosed embodiments. For example, although the implementation of various parts described above may be embodied in a hardware device, it may also be implemented as a software only solution, e.g., an installation on an existing server or mobile device.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various embodiments. This method of disclosure, however, is not to be interpreted as reflecting an intention that the claimed subject matter requires more features than are expressly recited in each claim. Rather, claimed subject matter may lie in less than all features of a single foregoing disclosed embodiment.

In some embodiments, numbers describing the number of ingredients and attributes are used. It should be understood that such numbers used for the description of the embodiments use the modifier “about”, “approximately”, or “substantially” in some examples. Unless otherwise stated, “about”, “approximately”, or “substantially” indicates that the number is allowed to vary by ±20%. Correspondingly, in some embodiments, the numerical parameters used in the description and claims are approximate values, and the approximate values may be changed according to the required features of individual embodiments. In some embodiments, the numerical parameters should consider the prescribed effective digits and adopt the method of general digit retention. Although the numerical ranges and parameters used to confirm the breadth of the range in some embodiments of the present disclosure are approximate values, in specific embodiments, settings of such numerical values are as accurate as possible within a feasible range.

For each patent, patent application, patent application publication, or other materials cited in the present disclosure, such as articles, books, specifications, publications, documents, or the like, the entire contents of which are hereby incorporated into the present disclosure as a reference. The application history documents that are inconsistent or conflict with the content of the present disclosure are excluded, and the documents that restrict the broadest scope of the claims of the present disclosure (currently or later attached to the present disclosure) are also excluded. It should be noted that if there is any inconsistency or conflict between the description, definition, and/or use of terms in the auxiliary materials of the present disclosure and the content of the present disclosure, the description, definition, and/or use of terms in the present disclosure is subject to the present disclosure.

Finally, it should be understood that the embodiments described in the present disclosure are only used to illustrate the principles of the embodiments of the present disclosure. Other variations may also fall within the scope of the present disclosure. Therefore, as an example and not a limitation, alternative configurations of the embodiments of the present disclosure may be regarded as consistent with the teaching of the present disclosure. Accordingly, the embodiments of the present disclosure are not limited to the embodiments introduced and described in the present disclosure explicitly.

1. A method for optimization of fracture parameters of segmented multi-cluster fracturing in a horizontal well of a continental shale applied to hydraulic fracturing construction, the method being realized based on a processor, comprising:
S1: establishing a fully coupling fluid-solid numerical model of multi-cluster fracture extension in a horizontal well of a continental shale gas by using a finite element manner and a cohesive unit manner, and based on an influence of large lithological and stress differences between layers of the continental shale, a development of compartmentalized interlayers, an inter-seam stress interference, and a dynamic distribution of flow rate between clusters, introducing a tubular flow unit; including:
S11: establishing a fluid-solid coupling control equation, a coupling control equation of rock solid skeleton deformation and fluid flow, a mass conservation equation of fluid seepage, and a flow velocity equation of fluid within the rock, respectively, as following equations including:
$${\int }_{V} ( \overline{σ} - {p}_{w} I ) \cdot {δ}_{ε} {d}_{V} = {\int }_{S} t \cdot {δ}_{v} {d}_{S} + {\int }_{V} f \cdot {δ}_{v} {d}_{V} , \qquad ( 1 )$$
$${\int }_{V} \frac{1}{J} \frac{d}{dt} ( J {ρ}_{w} {φ}_{w} ) {d}_{V} + {\int }_{S} {ρ}_{w} {φ}_{w} {n}^{T} \cdot {v}_{w} {d}_{S} = 0 , \qquad ( 2 )$$
$${v}_{w} = - \frac{1}{{φ}_{w} g {ρ}_{w}} k ( \frac{\partial {p}_{w}}{\partial x} - {ρ}_{w} g ) , [ [ … ] ] \qquad ( 3 )$$
wherein σ is an effective stress matrix in Pa, p_{w} is a pore pressure in Pa, I is a unit matrix in dimensionless units, δ_{ε} is an imaginary strain rate matrix in s−1, δᵥ is an imaginary velocity vector in m/s; t is a surface force vector in N/m²; f is a body force vector in N/m³; J is a change rate of rock volume in dimensionless units, ρ_{w} is a fluid density in kg/m³; φ_{w} is a porosity in dimensionless units, n^{T} is an external normal direction vector of a surface S in dimensionless units; and x is a space vector in meters; g is a gravitational acceleration in m/s²; and k is a rock skeleton permeability tensor in m/s;
S12: establishing an in-seam fluid flow equation, a fluid tangential flow equation, a fluid mass conservation equation, and a fracturing fluid filtration loss equation, respectively, as following equations including:
$$q = - \frac{{w}^{3}}{12 μ} ∇ p , \qquad ( 4 )$$
$$\frac{{\partial }_{w}}{{\partial }_{t}} + ∇ \cdot q + ( {q}_{t} + {q}_{b} ) = Q ( t ) δ ( x , y ) , \qquad ( 5 )$$
$$\{ \begin{matrix}{q}_{t} = {c}_{t} ( {p}_{f} - {p}_{t} ) \\ {q}_{b} = {c}_{b} ( {p}_{f} - {p}_{b} )\end{matrix} , \qquad ( 6 )$$
wherein q is a tangential flow in m³/s; Q(t) is a source term, which represents a rate of external supply or extraction of fluid inside a fracture; ∇p is a pressure drop gradient in a length direction of a cohesive unit in Pa/m; w is a fracture width in m; and μ is a fracturing fluid viscosity in Pa·s; and qₜ is a normal flow into an upper surface of the cohesive unit, and q_{b} is a normal flow into a lower surface of the cohesive unit in m³/s; cₜ is a filtration loss coefficient of an upper surface of a hydraulic fracture in m³/(Pa·s), c_{b} is a filtration loss coefficient of a lower surface of the hydraulic fracture in m³/(Pa·s); pₜ is a pore pressure at the upper surface of the hydraulic fracture in Pa, and p_{b} is a pore pressure at the lower surface of the hydraulic fracture in Pa; and p_{f} is a fluid pressure within the hydraulic fracture in Pa;
S13: establishing a fracture extension criterion equation, a damage equation for the cohesive unit, and a stiffness degradation criterion equation for evolution of unit damage, as following equations including:
$${\{ \frac{〈 {σ}_{n} 〉}{{σ}_{n}^{0}} \}}^{2} + {\{ \frac{〈 {τ}_{s} 〉}{{τ}_{s}^{0}} \}}^{2} + {\{ \frac{〈 {τ}_{t} 〉}{{τ}_{t}^{0}} \}}^{2} , \qquad ( 7 )$$
$$\{ \begin{matrix}\begin{matrix}{σ}_{n} = \{ \begin{matrix}( 1 - D ) \overline{{σ}_{n}} & \overline{{σ}_{n}} \geq 0 \\ \overline{{σ}_{n}} & \overline{{σ}_{n}} < 0\end{matrix} \\ {τ}_{s} = ( 1 - D ) {τ}_{s}\end{matrix} \\ {τ}_{t} = ( 1 - D ) \overline{{τ}_{t}}\end{matrix} , D = \frac{{δ}_{f} ( {δ}_{m} - {δ}_{o} )}{{δ}_{m} ( {δ}_{f} - {δ}_{o} )} , \qquad ( 8 )$$
wherein σₙ is a normal stress actually borne by the cohesive unit in Pa, τₛ and τₜ are tangential stresses actually borne by the cohesive unit in two directions in Pa; a symbol < > indicates that the normal stress actually borne by the cohesive unit takes positive values only; σₙ⁰ is a tensile resistance of the rock, τₛ⁰ and τₜ^{0o} are shear resistances of the rock; σₙ is a stress determined in a normal direction of the cohesive unit according to an undamaged front line elastic criterion under a current strain, τ̅ₛ is a stress determined in a tangential direction of the cohesive unit according to the undamaged front line elastic criterion under the current strain; D is a damage factor in dimensionless units and in a range of 0-1, when the damage factor is 0, a material is undamaged, and when the damage factor is 1, the material is fully damaged and the fracture begins to expand; σ₀ is a displacement at a time of initial damage in meters, δ_{f} is a displacement when the cohesive unit is completely destroyed in meters; and δₘ is a maximum displacement attained in a loading process in meters;
S14: establishing a fluid dynamic distribution equation among multi-cluster hydraulic fractures, and establishing a fluid energy conservation equation, a wellbore friction pressure drop equation, and a perforation aperture friction pressure drop equation, respectively, as following equations including:
$${P}_{0} = {\sum }_{i}^{N} {P}_{i} + Δ {P}_{w} + Δ {P}_{pf} , ( i = 1 , 2 , … , N ) , ) \qquad ( 9 )$$
$$Δ {P}_{w} = ρ g Δ Z = ( {C}_{L} + {K}_{i} ) \frac{ρ {v}^{2}}{2} , {C}_{L} = \frac{{f}_{L}}{{D}_{h}} , \qquad ( 10 )$$
$$Δ {P}_{pf} = K \frac{ρ {v}^{2}}{2} , \qquad ( 11 )$$
wherein P₀ is a fluid pressure at an injection node in MPa; Pᵢ is a fluid pressure at an entrance of an ith cluster of the multi-cluster hydraulic fractures in MPa; ΔP_{w} is a wellbore pressure drop friction in MPa; ΔP_{pf} is an aperture pressure drop friction in MPa; and N is a count of perforation clusters within a single fracturing section in clusters; ΔZ is an elevation difference between two nodes of a tubular unit in meters; ΔZ=Z₁−Z₂, Z₁ and Z₂ are elevations of the two nodes in m; ρ is a fluid density in kg/m³; g is the gravitational acceleration in m/s²; v is a flow rate of fluid within the tubular unit in m/s; C_{L} is a loss coefficient; f_{L} is a friction coefficient of a tubular; L is a length of the tubular in meters, Kᵢ is a directional loss coefficient in mm; and Dₕ is a hydraulic diameter or pipe diameter in meters; and K is a pressure loss coefficient of a connecting unit in dimensionless units; and
assigning different rock mechanics parameters to each reservoir location based on a geological data and experimental test results, wherein the rock mechanics parameters include a modulus of elasticity, a Poisson's ratio, a tensile strength, and an angle of internal friction; and
assigning different geostress parameters to each reservoir location based on geological exploration and downhole measurement data, wherein the geostress parameters include a magnitude and direction of stress;
S2: performing a layer-crossing extension simulation of a single-cluster hydraulic fracture under conditions of different injection displacements and fracturing fluid viscosities, and filtering an optimal engineering parameter of the single-cluster hydraulic fracture for controlling a hydraulic fracturing equipment to realize a layer-crossing extension with a goal of the hydraulic fracture penetrating through a high-quality reservoir;
S3: calculating an engineering parameter of the multi-cluster hydraulic fractures for realizing the layer-crossing extension based on the filtered engineering parameter of the single-cluster hydraulic fracture for realizing the layer-crossing extension in S2; and
S4: based on the filtered engineering parameter of the multi-cluster hydraulic fractures for realizing the layer-crossing extension in S3, calculating equilibrium expansion indexes of the multi-cluster hydraulic fractures and ground construction pressures under different perforation parameters, filtering an optimal perforation parameter based on a goal of balanced development of the multi-cluster hydraulic fractures and the ground construction pressures not exceeding a safety limit pressure; and controlling a diameter gun to perforate a wellbore of a ZX well based on a count of perforations and a perforation aperture diameter of the optimal perforation parameter;
wherein in S2, a layer-crossing extension pattern of the single-cluster hydraulic fracture under the conditions of different injection displacements and fracturing fluid viscosities is simulated, and a minimum injection displacement and a fracturing fluid viscosity for the single-cluster hydraulic fracture to completely penetrate through the high-quality reservoir are used as the optimal engineering parameter of the single-cluster hydraulic fracture for realizing the layer-crossing extension; and
in S3, an injection displacement or a fracturing fluid viscosity of the single-cluster hydraulic fracture filtered in S2 is amplified, further including:
determining an amplification factor based on the count of perforation clusters within the single fracturing section, the first preset value, and a second preset value;
amplifying an optimal injection displacement for the single-cluster hydraulic fracture to determine an optimal injection displacement for the multi-cluster hydraulic fracture based on the amplification factor, and using an optimal fracturing fluid viscosity for the single-cluster hydraulic fracture as an optimal fracturing fluid viscosity for the multi-cluster hydraulic fractures; or amplifying an optimal injection displacement and an optimal fracturing fluid viscosity of the single-cluster hydraulic fracture based on the amplification factor, respectively to obtain an optimal injection displacement and an optimal fracturing fluid viscosity of the multi-cluster hydraulic fractures;
applying the optimal injection displacement and the optimal fracturing fluid viscosity of the multi-cluster hydraulic fractures to hydraulic fracturing operations; and
when the first preset value is 0.05, and the second preset value is 1, a calculation formula of the engineering parameter of the multi-cluster hydraulic fractures for realizing the layer-crossing extension is shown as a following equation:
$$\{ \begin{matrix}{Q}_{0} = ( 1 + 0.05 N ) {NQ}_{1} \\ {μ}_{0} = {μ}_{1}\end{matrix} or \{ \begin{matrix}{Q}_{0} = {NQ}_{1} \\ {μ}_{0} = ( 1 + 0.05 N ) {μ}_{1}\end{matrix} , \qquad ( 12 )$$
wherein Q₀ is an optimal injection displacement of the multi-cluster hydraulic fractures for realizing the layer-crossing extension in m³/min; N is the count of perforation clusters within the single fracturing section in clusters; Q₁ is an optimal injection displacement of the single-cluster hydraulic fracture for realizing layer-crossing extension in m³/min; μ₀ is an optimal fracturing fluid viscosity of the multi-cluster hydraulic fractures for realizing the layer-crossing extension in mPa·s; and μ₁ is a fracturing fluid viscosity of the single-cluster hydraulic fracture for realizing the layer-crossing extension in mPa·s.

2. (canceled)

3. (canceled)

4. The method of claim 1, wherein in S4, the equilibrium expansion indexes of the multi-cluster hydraulic fractures and the ground construction pressures under the different perforation parameters are determined based on following equations:
$$\{ \begin{matrix}\overline{{Q}_{f}} = \frac{{Q}_{0}}{N} \\ {δ}_{Q} = max ( \frac{{Q}_{max} - \overline{{Q}_{f}}}{\overline{{Q}_{f}}} , \frac{\overline{{Q}_{f}} - {Q}_{min}}{\overline{{Q}_{f}}} )\end{matrix} \qquad ( 13 )$$
$$\{ \begin{matrix}Δ {P}_{pf , n} = 0.807249 \times \frac{ρ}{{n}^{2} {D}_{P}^{4} {C}^{2}} {Q}_{0}^{2} \\ Δ {P}_{wf} = λ \frac{{L}_{w}}{{D}_{w}} \frac{{v}^{2} ρ}{2} \\ {P}_{D} = 0.01 {HP}_{h} - ρ gH + Δ {P}_{pf , n} + Δ {P}_{wf}\end{matrix} \qquad ( 14 )$$
wherein δ_{Q} is the equilibrium expansion index of the multi-cluster hydraulic fractures in dimensionless units; Q̅_{f} is an average inlet flow of the multi-cluster hydraulic fractures in m³/min; Qₘₐₓ is a maximum inlet flow in each cluster of the multi-cluster hydraulic fractures in m³/min, Qₘᵢₙ is a minimum inlet flow in each cluster of the multi-cluster hydraulic fractures in m³/min; and ΔP_{pf,n} is an aperture friction pressure drop corresponding to n perforations in a single cluster in MPa; ΔP_{wf} is a wellbore fluid flow friction in MPa; λ is a hydraulic friction coefficient in dimensionless units; L_{w} is a wellbore length in meters; D_{w} is a wellbore diameter in meters; v is a fracturing fluid flow rate in m/s; and p is the fluid density in kg/m³; Dₚ is a perforation aperture diameter in meters; n is a count of perforations in a single perforation cluster; C is an empirical coefficient with a range of 0.5˜0.9, with a value of C close to 0.5 before perforation aperture abrasion, and close to 0.9 after the perforation aperture abrasion; P_{D} is a ground construction pressure in MPa; H is a plumb depth of the horizontal well in meters; Pₕ is a hydraulic fracture extension pressure gradient in MPa/100 m; and g is the gravitational acceleration, g≈9.8 m/s²; and
a perforation parameter satisfying δ_{Q}≤0.2 and P_{D}≤P_{L} is selected as the optimal perforation parameter, and the perforation parameter includes a count of perforations and a perforation aperture diameter.
